(19) United States
(12) Patent Application Publication
(10) Pub. No.: US 2023/0067538 A1
(43) Pub. Date: Mar. 2, 2023

(54) AUTONOMOUS VEHICLE MANEUVER IN RESPONSE TO EMERGENCY PERSONNEL HAND SIGNALS

(71) Applicant: TuSimple, Inc., San Diego, CA (US)

(72) Inventors: Hunter Scott Willoughby, San Diego, CA (US); Scott Douglas Foster, San Diego, CA (US); Dishi Li, Ann Arbor, MI (US); Mohammad Poorsartep, Los Gatos, CA (US)

(21) Appl. No.: 17/823,698

(22) Filed: Aug. 31, 2022

Related U.S. Application Data
(60) Provisional application No. 63/239,605, filed on Sep. 1, 2021.
(60) Provisional application No. 63/273,868, filed on Oct. 29, 2021.

(51) Int. Cl. B60W 60/00; G08G 1/09; G06V 20/58; G06V 40/20; G06V 10/44; G06V 20/70

(52) U.S. Cl. CPC B60W 60/0015; G06V 10/44; G06V 20/58; G06V 20/70; G06V 40/28; G08G 1/09; B60W 2420/42; B60W 2420/52; B60W 2552/50; B60W 2554/402; B60W 2554/406; B60W 2555/60; B60W 2556/45

(57) ABSTRACT

A control device associated with an autonomous vehicle detects that an emergency personnel is altering traffic on a road using an emergency-related hand signal to divert the traffic from a road anomaly, such as a road accident. The control device determines an interpretation of the emergency-related hand signal. The control device determines a proposed trajectory for the autonomous vehicle according to the interpretation of the emergency-related hand signal. In certain embodiments, the control device may navigate the autonomous vehicle according to the interpretation of the emergency-related hand signal. In certain embodiments, the control device may transmit the proposed trajectory to an oversight server for confirmation. In certain embodiments, the oversight may confirm or override the proposed trajectory.

### RELATED APPLICATION AND CLAIM TO PRIORITY

This application claims priority to U.S. Provisional Application No. 63/239,605 filed Sep. 1, 2021 and titled “HANDSIGNAL DETECTION SYSTEM AND METHOD FOR AN AUTONOMOUS VEHICLE,” and U.S. Provisional Application No. 63/273,868 filed Oct. 29, 2021 and titled “SYSTEM AND METHOD FOR AN AUTONOMOUS VEHICLE,” which are incorporated herein by reference.

### TECHNICAL FIELD

The present disclosure relates generally to autonomous vehicles. More particularly, the present disclosure is related to av maneuver in response to emergency hand signals.

### BACKGROUND

One aim of autonomous vehicle technology is to provide vehicles that can safely navigate with limited or no driver assistance. In some situations, a person, such as a construction worker or a law enforcement officer may alter or direct traffic using hand signals or a hand-held sign. Without a human driver, it is challenging to determine the intent of the hand signals or the hand-held sign.

### SUMMARY

This disclosure recognizes various problems and previously unmet needs related to autonomous vehicle navigation, and more specifically to the lack of technology in efficiently detecting hand signals (and hand-held signs) when used to direct or alter the traveling path of the autonomous vehicle on a road. In an example scenario, assume that an autonomous vehicle is traveling on a road and encounters a person that is altering the traffic using hand signals (or a hand-held sign). Without determining the interpretation of the hand signal (or the hand-held sign), the autonomous vehicle would not be able to abide by the traffic control instruction provided by the person. This may lead to unsafe driving conditions for the autonomous vehicle, other vehicles on the road, and pedestrians. Certain embodiments of the present disclosure provide unique technical solutions to technical problems of current autonomous vehicle technologies, including those problems described above to improve the autonomous vehicle navigation.

### Hand Signal Detection System Using Oversight

This disclosure contemplates systems and methods configured for hand signal detection using an oversight server. In an example scenario, when the autonomous vehicle is traveling on a road, it may encounter a person that is altering the traffic using hand signals. The autonomous vehicle may be associated with a control device that is configured to facilitate the autonomous driving of the autonomous vehicle.

The control device may detect the hand signal from sensor data captured by sensors of the autonomous vehicle. The control device may determine an interpretation of the hand signal using a hand signal machine learning module that is pre-trained to predict interpretations of various hand signals from the sensor data. The control device may determine a proposed trajectory for the autonomous vehicle according to the interpretation of the hand signal. The proposed trajectory may follow the interpretation of the hand signal. For example, if the hand signal means all vehicles stop, the proposed trajectory may be to stop the autonomous vehicle.

In certain embodiments, the control device may have the autonomy to navigate the autonomous vehicle independently according to the proposed trajectory. In certain embodiments, the control device may have partial autonomy and may need confirmation or another trajectory from the oversight server. For example, the control device may transmit the sensor data and the proposed trajectory to the oversight server. The oversight server may be implemented by distributed cloud computing and therefore have more computation resources compared to the control device that is onboard the autonomous vehicle.

The oversight server may determine whether the hand signal is in use. For example, the oversight may be configured to differentiate between when an authorized person, such as a construction worker, a law enforcement officer, or emergency personnel is performing the hand signal or a bad actor is attempting to tamper with the autonomous vehicle by performing the hand signal. The oversight server may also determine whether the proposed trajectory that is determined by the control device causes the autonomous vehicle to go outside of an operational design domain that indicates pre-mapped areas where the autonomous vehicle can autonomously travel. If the oversight server determines that the hand signal is in use and the proposed trajectory does not lead the autonomous vehicle to go outside of the operational design domain, the oversight server transmits a confirmation message to the control device to navigate the autonomous vehicle according to the proposed trajectory. Otherwise, the oversight server may determine a second proposed trajectory and transmit it to the control device. Similar operations may be performed when a hand-held signal is detected.

In one embodiment, a system comprises an autonomous vehicle, a control device associated with the autonomous vehicle, and an oversight server. The autonomous vehicle is configured to travel along a road, wherein the autonomous vehicle comprises at least one sensor. The control device comprises a first processor configured to access sensor data captured by the at least one sensor, wherein the sensor data provides information about at least a portion of an area in front of the autonomous vehicle. The first processor detects, from the sensor data, that a person is altering a traffic flow on the road using a hand signal. The first processor determines an interpretation of the hand signal. The first processor determines a proposed trajectory for the autonomous vehicle according to the interpretation of the hand signal. The first processor transmits at least one of the proposed trajectory and the sensor data to an oversight server. The oversight server is operably coupled with the control device. The oversight server comprises a second processor configured to receive the at least one of the proposed trajectory and the sensor data. The second processor determines whether the hand signal is in use to alter the traffic flow. In response to determining that the hand signal is in use to alter the traffic flow, the second processor determines whether the proposed trajectory causes the autonomous vehicle to go outside of an operational design domain that indicates pre-mapped geographical areas where the autonomous vehicle is able to autonomously travel. In response to determining that the proposed trajectory does not cause the autonomous vehicle to go outside of the operational design domain, the second processor transmits, to the control device, an instruction that indicates to perform the proposed trajectory.

In one embodiment, a system comprises an autonomous vehicle and a control device associated with the autonomous vehicle. The autonomous vehicle is configured to travel along a road, wherein the autonomous vehicle comprises at least one sensor. The control device comprises a first processor configured to access sensor data captured by the at least one sensor, wherein the sensor data provides information about at least a portion of an area in front of the autonomous vehicle. The first processor detects, from the sensor data, a person that is altering a traffic flow on the road using a hand signal. The first processor determines an interpretation of the hand signal. The first processor determines a proposed trajectory for the autonomous vehicle according to the interpretation of the hand signal. The first processor navigates the autonomous vehicle according to the proposed trajectory.

### Autonomous Vehicle Maneuver in Response to Construction Zone Hand Signals

This disclosure contemplates systems and methods configured for autonomous vehicle maneuver in response to construction zone hand signals. In some cases, a hand signal may be specific to a construction zone. For example, a construction worker may wave their hands to direct traffic in a specific direction to divert from the construction site, raise their hands to instruct the oncoming traffic to stop, or any other construction zone-related hand signals.

The disclosed system is configured to detect construction zone-related hand signals. For example, the control device onboard an autonomous vehicle may detect a construction zone and that a construction worker is altering the traffic using a construction zone-related hand signal. In response, the control device may determine an interpretation of the construction zone-related hand signal and a proposed trajectory for the autonomous vehicle according to the interpretation of the construction zone-related hand signal. The control device may navigate the autonomous vehicle according to the proposed trajectory.

In certain embodiments, the control device may transmit the proposed trajectory to the oversight server. The oversight server may confirm, update, or override the proposed trajectory, similar to that described above.

In one embodiment, a system comprises an autonomous vehicle and a control device associated with the autonomous vehicle. The autonomous vehicle is configured to travel along a road, wherein the autonomous vehicle comprises at least one sensor. The control device comprises a first processor configured to access sensor data captured by the at least one sensor, wherein the sensor data provides information about at least a portion of an area in front of the autonomous vehicle. The first processor detects, from the sensor data, a construction zone. The first processor detects, from the sensor data, that a construction worker is altering a traffic flow using a construction zone-related hand signal, wherein the construction worker is on a traffic lane adjacent to the construction zone and facing oncoming traffic. The first processor determines an interpretation of the construction zone-related hand signal. The first processor determines a proposed trajectory for the autonomous vehicle according to the interpretation of the construction zone-related hand signal. The first processor navigates the autonomous vehicle according to the proposed trajectory.

In one embodiment, a system comprises an autonomous vehicle, a control device associated with the autonomous vehicle, and an oversight server. The autonomous vehicle is configured to travel along a road, wherein the autonomous vehicle comprises at least one sensor. The control device comprises a first processor configured to access sensor data captured by the at least one sensor, wherein the sensor data provides information about at least a portion of an area in front of the autonomous vehicle. The first processor detects, from the sensor data, a construction zone. The first processor detects, from the sensor data, that a construction worker is altering a traffic flow using a construction zone-related hand signal, wherein the construction worker is on a traffic lane adjacent to the construction zone and facing oncoming traffic. The first processor determines an interpretation of the construction zone-related hand signal. The first processor determines a proposed trajectory for the autonomous vehicle according to the interpretation of the construction zone-related hand signal. The first processor transmits at least one of the proposed trajectory and the sensor data to an oversight server. The oversight server is operably coupled to the control device. The oversight server comprises a second processor configured to receive the at least one of the proposed trajectory and the sensor data. The second processor determines whether the construction zone-related hand signal is in use to alter the traffic flow. In response to determining that the construction zone-related hand signal is in use to alter the traffic flow, the second processor determines whether the proposed trajectory causes the autonomous vehicle to go outside of an operational design domain that indicates pre-mapped geographical areas where the autonomous vehicle is able to autonomously travel. In response to determining that the proposed trajectory does not cause the autonomous vehicle to go outside of the operational design domain, the second processor transmits, to the control device, an instruction that indicates to perform the proposed trajectory.

### Autonomous Vehicle Maneuver in Response to Emergency Hand Signals

This disclosure contemplates systems and methods configured for autonomous vehicle maneuver in response to emergency hand signals. In some cases, a hand signal may be specific to a road anomaly, such as a road accident or congested traffic. For example, emergency personnel may wave their hands to direct traffic in a specific direction to avoid the road anomaly, raise their hands to instruct the oncoming traffic to stop, or any other emergency-related hand signals.

The disclosed system is configured to detect emergency-related hand signals. For example, the control device onboard an autonomous vehicle may detect a road anomaly and that emergency personnel is altering the traffic using an emergency-related hand signal. In response, the control device may determine an interpretation of the emergency-related hand signal and a proposed trajectory for the autonomous vehicle according to the interpretation of the emergency-related hand signal. The control device may navigate the autonomous vehicle according to the proposed trajectory. In certain embodiments, the control device may transmit the proposed trajectory to the oversight server. The oversight server may confirm, update, or override the proposed trajectory, similar to that described above.

In one embodiment, a system comprises an autonomous vehicle and a control device associated with the autonomous vehicle. The autonomous vehicle is configured to travel along a road, wherein the autonomous vehicle comprises at least one sensor. The control device comprises a first processor configure to access sensor data captured by the at least one sensor, wherein the sensor data provides information about at least a portion of an area in front of the autonomous vehicle. The first processor detects, from the sensor data, a road anomaly comprising one of a road accident, a road closure, or congested traffic. The first processor detects, from the sensor data, that an emergency personnel is altering a traffic flow using an emergency-related hand signal, wherein the emergency personnel is on a traffic lane adjacent to the road anomaly and facing oncoming traffic. The first processor determines an interpretation of the emergency-related hand signal. The first processor determines a proposed trajectory for the autonomous vehicle according to the interpretation of the emergency-related hand signal. The first processor navigates the autonomous vehicle according to the proposed trajectory.

In one embodiment, a system comprises an autonomous vehicle, a control device associated with the autonomous vehicle, and an oversight server. The autonomous vehicle is configured to travel along a road, wherein the autonomous vehicle comprises at least one sensor. The control device comprises a first processor configured to access sensor data captured by the at least one sensor, wherein the sensor data provides information about at least a portion of an area in front of the autonomous vehicle. The first processor detects, from the sensor data, a road anomaly comprising one of a road accident, a road closure, or congested traffic. The first processor detects, from the sensor data, that an emergency personnel is altering a traffic flow using an emergency-related hand signal, wherein the emergency personnel is on a traffic lane adjacent to the road anomaly and facing oncoming traffic. The first processor determines an interpretation of the emergency-related hand signal. The first processor determines a proposed trajectory for the autonomous vehicle according to the interpretation of the emergency-related hand signal. The first processor transmits at least one of the proposed trajectory and the sensor data to an oversight server. The oversight server is operably coupled with the control device. The oversight server comprises a second processor configured to receive the at least one of the proposed trajectory and the sensor data. The second processor determines whether the emergency-related hand signal is in use to alter the traffic flow. In response to determining that the emergency-related hand signal is in use to alter the traffic flow, the second processor determines whether the proposed trajectory causes the autonomous vehicle to go outside of an operational design domain that indicates pre-mapped geographical areas where the autonomous vehicle is able to autonomously travel. In response to determining that the proposed trajectory does not cause the autonomous vehicle to go outside of the operational design domain, second processor transmits, to the control device, an instruction that indicates to perform the proposed trajectory.

Accordingly, the disclosed system is integrated into an additional practical application of improving autonomous vehicle navigation. This leads to a safer driving experience for autonomous vehicles, other vehicles, and pedestrians.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system configured for hand signal detection;

FIG. 2 illustrates an example operational flow of the system of FIG. 1;

FIG. 3 illustrates an embodiment of a system configured for implementing communication between autonomous vehicles, an oversight server, and a third party;

FIG. 4 illustrates an embodiment of a data flow in a system between an autonomous vehicle and an oversight system;

FIG. 5 illustrates an example flowchart of a method for autonomous vehicle navigation according to a hand signal using an oversight server;

FIG. 6 illustrates an example flowchart of a method for autonomous vehicle navigation according to a construction zone hand signal;

FIG. 7 illustrates an example flowchart of a method for autonomous vehicle navigation according to an emergency-related hand signal;

FIG. 8 illustrates a block diagram of an example autonomous vehicle configured to implement autonomous driving operations;

FIG. 9 illustrates an example system for providing autonomous driving operations used by the autonomous vehicle of FIG. 8; and

FIG. 10 illustrates a block diagram of an in-vehicle control computer included in the autonomous vehicle of FIG. 8.

### DETAILED DESCRIPTION

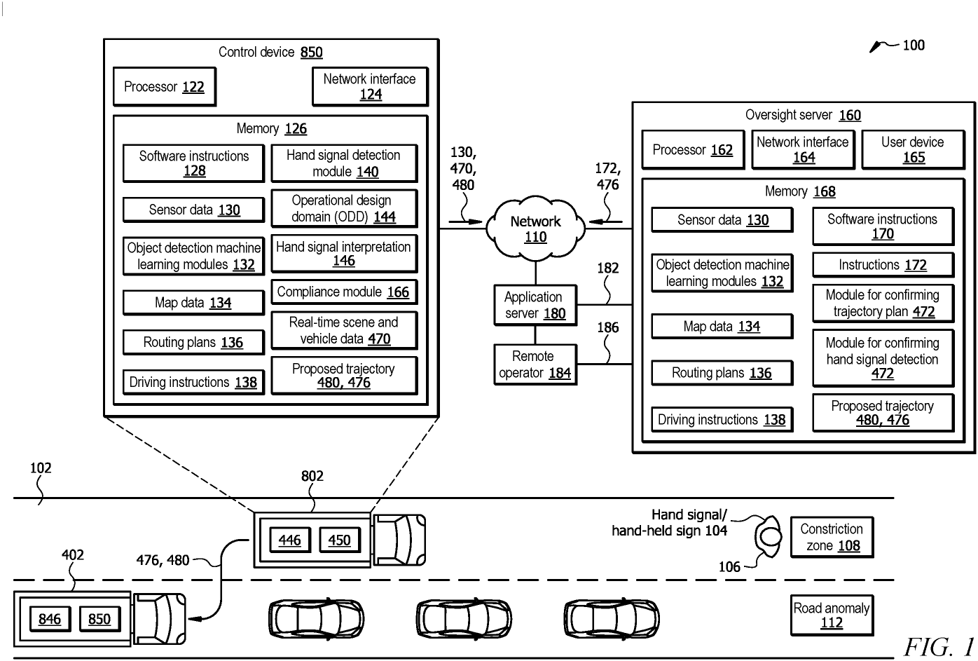

As described above, previous technologies fail to provide efficient, reliable, and safe solutions to detect hand signals (or hand-held signs) when used to direct the autonomous vehicle on a road. The present disclosure provides various systems, methods, and devices to detect hand signals (or hand-held signs), determine an interpretation of the hand signals (or the hand-held signs), and update the navigation of the autonomous vehicle according to the determined interpretation of the hand signals (or the hand-held signs). Embodiments of the present disclosure and its advantages may be understood by referring to FIGS. 1 through 10. FIGS. 1 through 10 are used to describe a system and method to detect hand signals (or hand-held signs), determine an interpretation of the hand signals (or the hand-held signs), and update the navigation of the autonomous vehicle according to the determined interpretation of the hand signals (or the hand-held signs).

### System Overview

FIG. 1 illustrates an embodiment of a system 100 configured to determine an interpretation of a hand signal 104 or a hand-held sign 104 experienced by an autonomous vehicle 802, and determine a proposed trajectory according to the hand signal 104 or the hand-held sign 104. FIG. 1 further illustrates a simplified schematic of a road 102 traveled by an autonomous vehicle 802, where the autonomous vehicle 802 encounters or experiences a hand signal 104 or a hand-held sign 104. In this disclosure, operations that are described in response to detecting a hand signal 104 may be performed in response to detecting a respective or corresponding hand-held sign 104 that may convey the same interpretation 146 as the hand signal 104. In certain embodiments, system 100 comprises an oversight server 160 communicatively coupled with one or more autonomous vehicles 802 and an application server 180 via a network 110. Network 110 enables communication among the components of the system 100. Network 110 allows the oversight server 160 to communicate with autonomous vehicles 802, systems, application server 180, databases, devices, etc. Network 110 also allows the autonomous vehicle 802 to communicate with other autonomous vehicles 802, systems, oversight server 160, application server 180, databases, devices, etc. The autonomous vehicle 802 comprises a control device 850. Control device 850 comprises a processor 122 in signal communication with a memory 126. Memory 126 stores software instructions 128 that when executed by the processor 122, cause the control device 850 to execute one or more operations described herein. Oversight server 160 comprises a processor 162 in signal communication with a memory 168. Memory 168 stores software instructions 170 that when executed by the processor 162, cause the oversight server 160 to perform one or more operations described herein. In other embodiments, system 100 may not have all of the components listed and/or may have other elements instead of, or in addition to, those listed above. System 100 may be configured as shown or in any other configuration.

Vehicles traversing highways and roadways are legally required to comply with regulations and statues in the course of safe operation of the vehicle. For autonomous vehicles 802, particularly autonomous tractor trailers, the ability to recognize a malfunction in its systems, recognize instructions given by law enforcement, recognize instructions given by hand signals or hand-held signs, and stop safely are necessary for lawful and safe operation of the vehicle. Described below in detail are systems and methods for the safe and lawful operation of an autonomous vehicle on a roadway, including the execution of maneuvers that bring the autonomous vehicle in compliance with the law while signaling surrounding vehicles of its condition.

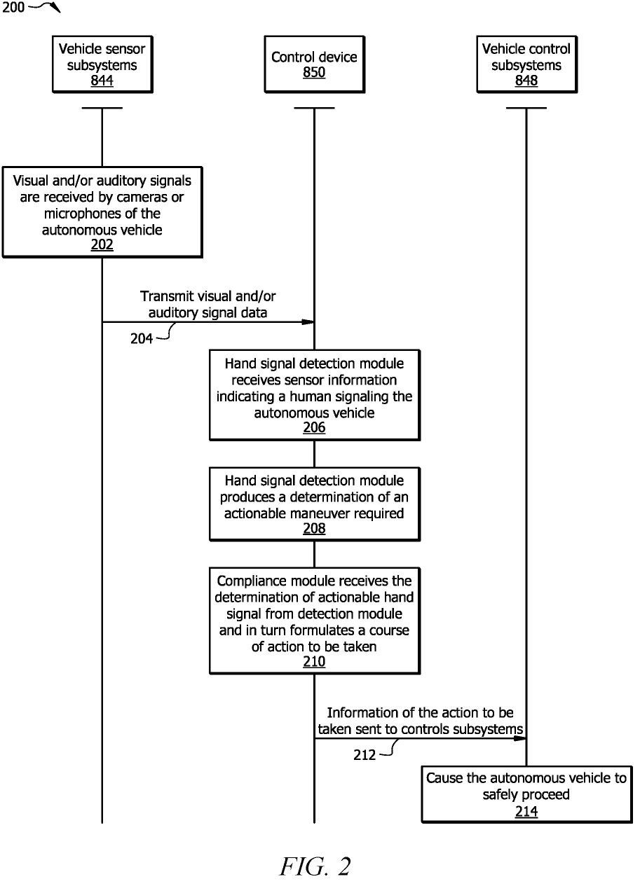

In an example scenario, assume that an autonomous vehicle 802 is traveling on a road 102 where someone is altering the traffic flow using a hand signal 104 and/or a hand-held sign 104. The system 100 (e.g., via the control device 850 and/or the oversight server 160) is configured to detect the hand signal 104 and/or the hand-held sign 104, determine what the hand signal 104 and/or the hand-held sign 104 means (i.e., the interpretation 146 of the hand signal 104 and/or the hand-held sign 104), determine a proposed trajectory 480, 476 for the autonomous vehicle 802 according to the observed hand signal 104 and/or the hand-held sign 104, and instruct the autonomous vehicle 802 to perform the proposed trajectory. This operation is described in greater detail in FIGS. 2-5.

In some cases, the autonomous vehicle 802 may encounter a construction worker 106 that is altering the traffic using a construction zone-related hand signal 104, where the construction worker 106 is adjacent to the construction zone 108. The system 100 determines the interpretation 146 of the construction zone-related hand signal 104 and a proposed trajectory 480, 476 for the autonomous vehicle 802 according to the interpretation 146 of the construction zone-related hand signal 104. This operation is described in greater detail in FIGS. 2-4 and 6.

In some cases, the autonomous vehicle 802 may encounter an emergency personnel 106 that is altering the traffic using an emergency-related hand signal 104, where the emergency personnel 106 is adjacent to a road anomaly 112, e.g., a road accident or congested traffic. The system 100 determines the interpretation 146 of the emergency-related hand signal 104 and a proposed trajectory 480, 476 for the autonomous vehicle 802 according to the interpretation 146 of the emergency-related hand signal 104. This operation is described in greater detail in FIGS. 2-4 and 7.

### System Components

Network 110 may include any interconnecting system capable of transmitting audio, video, signals, data, messages, or any combination of the preceding. Network 110 may include all or a portion of a local area network (LAN), a wide area network (WAN), a metropolitan area network (MAN), a personal area network (PAN), a wireless PAN (WPAN), an overlay network, a software-defined network (SDN), a virtual private network (VPN), a packet data network (e.g., the Internet), a mobile telephone network (e.g., cellular networks, such as 4G or 5G), a plain old telephone (POT) network, a wireless data network (e.g., WiFi, WiGig, WiMAX, etc.), a long term evolution (LTE) network, a universal mobile telecommunications system (UMTS) network, a peer-to-peer (P2P) network, a Bluetooth network, a near field communication (NFC) network, a Zigbee network, a Z-wave network, a WiFi network, and/or any other suitable network.

### Example Autonomous Vehicle

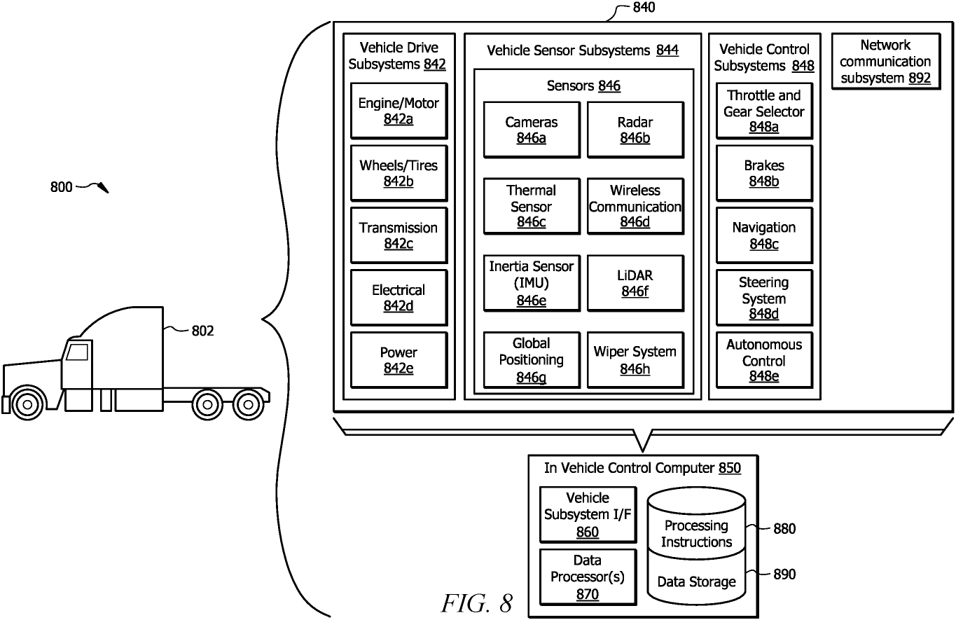

In one embodiment, the autonomous vehicle 802 may include a semi-truck tractor unit attached to a trailer to transport cargo or freight from one location to another location (see FIG. 8). The autonomous vehicle 802 is generally configured to travel along a road in an autonomous mode. The autonomous vehicle 802 may navigate using a plurality of components described in detail in FIGS. 8-10. The operation of the autonomous vehicle 802 is described in greater detail in FIGS. 8-10. The corresponding description below includes brief descriptions of certain components of the autonomous vehicle 802.

Control device 850 may be generally configured to control the operation of the autonomous vehicle 802 and its components and to facilitate autonomous driving of the autonomous vehicle 802. The control device 850 may be further configured to determine a pathway in front of the autonomous vehicle 802 that is safe to travel and free of objects or obstacles, and navigate the autonomous vehicle 802 to travel in that pathway. This process is described in more detail in FIGS. 8-10. The control device 850 may generally include one or more computing devices in signal communication with other components of the autonomous vehicle 802 (see FIG. 8). In this disclosure, the control device 850 may interchangeably be referred to as an in-vehicle control computer 850.

The control device 850 may be configured to detect objects on and around a road traveled by the autonomous vehicle 802 by analyzing the sensor data 130 and/or map data 134. For example, the control device 850 may detect objects on and around the road by implementing object detection machine learning modules 132. The object detection machine learning modules 132 may be implemented using neural networks and/or machine learning algorithms for detecting objects from images, videos, infrared images, point clouds, radar data, etc. The object detection machine learning modules 132 are described in more detail further below. The control device 850 may receive sensor data 130 from the sensors 846 positioned on the autonomous vehicle 802 to determine a safe pathway to travel. The sensor data 130 may include data captured by the sensors 846.

Sensors 846 may be configured to capture any object within their detection zones or fields of view, such as landmarks, lane markers, lane boundaries, road boundaries, vehicles, pedestrians, road/traffic signs, among others. In some embodiments, the sensors 846 may be configured to detect rain, fog, snow, and/or any other weather condition. The sensors 846 may include a detection and ranging (LiDAR) sensor, a radar sensor, a video camera, an infrared camera, an ultrasonic sensor system, a wind gust detection system, a microphone array, a thermocouple, a humidity sensor, a barometer, an inertial measurement unit, a positioning system, an infrared sensor, a motion sensor, a rain sensor, and the like. In some embodiments, the sensors 846 may be positioned around the autonomous vehicle 802 to capture the environment surrounding the autonomous vehicle 802. See the corresponding description of FIG. 8 for further description of the sensors 846.

### Control Device

The control device 850 is described in greater detail in FIG. 8. In brief, the control device 850 may include the processor 122 in signal communication with the memory 126 and a network interface 124. The processor 122 may include one or more processing units that perform various functions as described herein. The memory 126 may store any data and/or instructions used by the processor 122 to perform its functions. For example, the memory 126 may store software instructions 128 that when executed by the processor 122 causes the control device 850 to perform one or more functions described herein.

The processor 122 may be one of the data processors 870 described in FIG. 8. The processor 122 comprises one or more processors operably coupled to the memory 126. The processor 122 may be any electronic circuitry, including state machines, one or more central processing unit (CPU) chips, logic units, cores (e.g., a multi-core processor), field-programmable gate arrays (FPGAs), application-specific integrated circuits (ASICs), or digital signal processors (DSPs). The processor 122 may be a programmable logic device, a microcontroller, a microprocessor, or any suitable combination of the preceding. The processor 122 may be communicatively coupled to and in signal communication with the network interface 124 and memory 126. The one or more processors may be configured to process data and may be implemented in hardware or software. For example, the processor 122 may be 8-bit, 16-bit, 32-bit, 64-bit, or of any other suitable architecture. The processor 122 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processors may be configured to implement various instructions. For example, the one or more processors may be configured to execute software instructions 128 to implement the functions disclosed herein, such as some or all of those described with respect to FIGS. 1-10. In some embodiments, the function described herein is implemented using logic units, FPGAs, ASICs, DSPs, or any other suitable hardware or electronic circuitry.

Network interface 124 may be a component of the network communication subsystem 892 described in FIG. 8. The network interface 124 may be configured to enable wired and/or wireless communications. The network interface 124 may be configured to communicate data between the autonomous vehicle 802 and other devices, systems, or domains. For example, the network interface 124 may comprise an NFC interface, a Bluetooth interface, a Zigbee interface, a Z-wave interface, a radio-frequency identification (RFID) interface, a WIFI interface, a local area network (LAN) interface, a wide area network (WAN) interface, a metropolitan area network (MAN) interface, a personal area network (PAN) interface, a wireless PAN (WPAN) interface, a modem, a switch, and/or a router. The processor 122 may be configured to send and receive data using the network interface 124. The network interface 124 may be configured to use any suitable type of communication protocol as would be appreciated by one of ordinary skill in the art.

The memory 126 may be one of the data storages 890 described in FIG. 8. The memory 126 may be volatile or non-volatile and may comprise read-only memory (ROM), random-access memory (RAM), ternary content-addressable memory (TCAM), dynamic random-access memory (DRAM), and static random-access memory (SRAM). The memory 126 may include one or more of a local database, cloud database, network-attached storage (NAS), etc. The memory 126 may store any of the information described in FIGS. 1-10 along with any other data, instructions, logic, rules, or code operable to implement the function(s) described herein when executed by processor 122. For example, the memory 126 may store software instructions 128, sensor data 130, object detection machine learning module 132, map data 134, routing plan 136, driving instructions 138, hand signal detection module 140, operational design domain 144, hand signal/hand-held sign interpretation 146, real time scene and vehicle data 470, compliance module 166, proposed trajectories 480, 476, and/or any other data/instructions. The software instructions 128 include code that when executed by the processor 122 causes the control device 850 to perform one or more functions described herein, such as some or all of those described in FIGS. 1-10. The memory 126 comprises one or more disks, tape drives, or solid-state drives, and may be used as an over-flow data storage device to store programs when such programs are selected for execution, and to store instructions and data that are read during program execution.

Object detection machine learning modules 132 may be implemented by the processor 122 executing software instructions 128, and may be generally configured to detect objects and obstacles from the sensor data 130. The object detection machine learning modules 132 may be implemented using neural networks and/or machine learning algorithms for detecting objects from any data type, such as images, videos, infrared images, point clouds, Radar data, etc.

In some embodiments, the object detection machine learning modules 132 may be implemented using machine learning algorithms, such as Support Vector Machine (SVM), Naive Bayes, Logistic Regression, k-Nearest Neighbors, Decision Trees, or the like. In some embodiments, the object detection machine learning modules 132 may utilize a plurality of neural network layers, convolutional neural network layers, Long-Short-Term-Memory (LSTM) layers, Bi-directional LSTM layers, recurrent neural network layers, and/or the like, in which weights and biases of these layers are optimized in the training process of the object detection machine learning modules 132. The object detection machine learning modules 132 may be trained by a training dataset that may include samples of data types labeled with one or more objects in each sample. For example, the training dataset may include sample images of objects (e.g., vehicles, lane markings, pedestrians, road signs, obstacles, etc.) labeled with object(s) in each sample image. Similarly, the training dataset may include samples of other data types, such as videos, infrared images, point clouds, Radar data, etc. labeled with object(s) in each sample data. The object detection machine learning modules 132 may be trained, tested, and refined by the training dataset and the sensor data 130. The object detection machine learning modules 132 use the sensor data 130 (which are not labeled with objects) to increase their accuracy of predictions in detecting objects. For example, supervised and/or unsupervised machine learning algorithms may be used to validate the predictions of the object detection machine learning modules 132 in detecting objects in the sensor data 130.

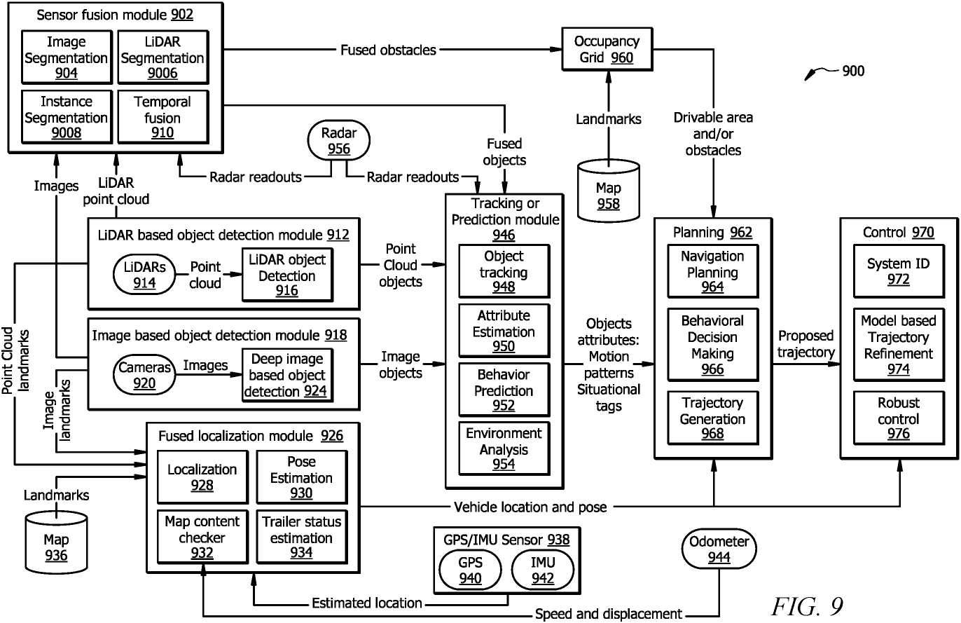

Map data 134 may include a virtual map of a city or an area that includes the road traveled by an autonomous vehicle 802. In some examples, the map data 134 may include the map 958 and map database 936 (see FIG. 9 for descriptions of the map 958 and map database 936). The map data 134 may include drivable areas, such as roads, paths, highways, and undrivable areas, such as terrain (determined by the occupancy grid module 960, see FIG. 9 for descriptions of the occupancy grid module 960). The map data 134 may specify location coordinates of road signs, lanes, lane markings, lane boundaries, road boundaries, traffic lights, obstacles, etc.

Routing plan 136 may be a plan for traveling from a start location (e.g., a first autonomous vehicle launchpad/landing pad) to a destination (e.g., a second autonomous vehicle launchpad/landing pad). For example, the routing plan 136 may specify a combination of one or more streets, roads, and highways in a specific order from the start location to the destination. The routing plan 136 may specify stages, including the first stage (e.g., moving out from a start location/launch pad), a plurality of intermediate stages (e.g., traveling along particular lanes of one or more particular street/road/highway), and the last stage (e.g., entering the destination/landing pad). The routing plan 136 may include other information about the route from the start position to the destination, such as road/traffic signs in that routing plan 136, etc.

Driving instructions 138 may be implemented by the planning module 962 (See descriptions of the planning module 962 in FIG. 9.). The driving instructions 138 may include instructions and rules to adapt the autonomous driving of the autonomous vehicle 802 according to the driving rules of each stage of the routing plan 136. For example, the driving instructions 138 may include instructions to stay within the speed range of a road traveled by the autonomous vehicle 802, adapt the speed of the autonomous vehicle 802 with respect to observed changes by the sensors 846, such as speeds of surrounding vehicles, objects within the detection zones of the sensors 846, etc.

Hand signal detection module 140 may be implemented by the processor 122 executing the software instructions 128, and may be generally configured to detect hand signals 104 and hand-held signs 104 and determine an interpretation 146 (e.g., the intent) of the detected hand signals 104 and hand-held signs 104. The hand signal detection module 140 may be implemented using neural networks and/or machine learning algorithms for detecting hand signals 104 and hand-held signs 104 from any data type, such as images, videos, infrared images, point clouds, Radar data, etc. In some embodiments, the hand signal detection module 140 may be implemented using machine learning algorithms, such as SVM, Naive Bayes, Logistic Regression, k-Nearest Neighbors, Decision Trees, or the like. In some embodiments, the hand signal detection module 140 may utilize a plurality of neural network layers, convolutional neural network layers, LSTM layers, Bi-directional LSTM layers, recurrent neural network layers, and/or the like, in which weights and biases of these layers are optimized in the training process of the hand signal detection module 140.

The hand signal detection module 140 may be trained by a training dataset that may include samples of data types each labeled with a respective hand signal 104 or a hand-held sign 104 in each respective sample data. For example, the training dataset may include sample images of people performing hand signals 104 and/or hand-held signs 104 (e.g., vehicles proceed, slow down, stop, pull over, etc.) labeled with an interpretation 146 of a respective hand signal 104 and/or hand-held sign 104 in each sample image. Similarly, the training dataset may include samples of other data types, such as videos, infrared images, point clouds, Radar data, etc. labeled with a hand signal 104 and/or hand-held sign 104 in each sample data. The hand signal detection module 140 may be trained, tested, and refined by the training dataset and the sensor data 130. The hand signal detection module 140 uses the sensor data 130 (which are not labeled with hand signals 104 or hand-held signs 104) to increase the accuracy of predictions in detecting hand signals 104 and hand-held signs 104 and respective interpretations 146. For example, supervised and/or unsupervised machine learning algorithms may be used to validate the predictions of the hand signal detection module 140 in detecting hand signals 104 and hand-held signs 104 in the sensor data 130.

The hand signal detection module 140 may determine that one or more pedestrians are altering traffic flow with hand signals or handheld signs based on analysis of sensor data 130 from sensors 846 in the vehicle sensor subsystems 844. The hand signal detection module 140 can then use the determination to send instructions for appropriate alteration of the autonomous vehicle’s trajectory to the planning module 962 (see FIG. 9). Alternatively, or additionally, the hand signal detection module 140 can create a packet of data including real-time scene and vehicle data 470 which is passed to the oversight server 160. The one or more processors 122 execute the operations that allow the system to operate autonomous vehicle 802 in accordance with the applicable regulations for areas with a human (e.g., pedestrian, traffic officer, a crossing-guard, construction worker, law enforcement officer, or first responder) controlling traffic flow with hand signals or hand-held signs. The sensor data 130 captured by the sensors 846 is provided to control device 850 so that the determination of the use of hand signals or hand-held signs can be made. The compliance module 166 may determine what action should be taken by the autonomous vehicle 802 to operate according to the applicable (i.e., local) regulations. The sensor data 130 captured by the sensors 846 may be provided to the compliance module 166 so that the best course of action in light of the autonomous vehicle’s status may be appropriately determined and performed. Alternatively, or additionally, the compliance module 166 may determine the course of action in conjunction with another operational or control module, such as the vehicle subsystems 840 (see FIG. 8), the planning module 962 (see FIG. 9), etc.

Compliance module 166 may be implemented by the processor 122 executing the software instructions 128, and may be configured to determine what action should be taken by the autonomous vehicle 802 to operate according to the applicable (i.e., local) regulations, such as road regulations. For example, the compliance module 166 may be aware of a location of the autonomous vehicle 802 and use that to determine the local road regulations, such as speed limit, whether there is a construction zone, a school zone, congested traffic, an accident, etc. Based on this information and/or any other data described herein, the compliance module 166 may determine an action for the autonomous vehicle 802 to take that follows the local road regulations. In certain embodiments, the compliance module 166 may work with the vehicle subsystems 840 (see FIG. 8) and any component(s) described in FIG. 9 to perform these operations.

### Oversight Server

Oversight server 160 may include one or more processing devices and is generally configured to oversee the operations of the autonomous vehicle 802 while they are in transit and oversee traveling of the autonomous vehicle 802. The oversight server 160 may also be configured to provide hardware and/or software resources to other components of the system 100. For example, the oversight server 160 may be configured to provide instructions 172, proposed trajectory 480, 476, among other data/instructions to one or more autonomous vehicles 802.

The oversight server 160 may comprise a processor 162, a network interface 164, a user interface 165, and a memory 168. The components of the oversight server 160 are operably coupled to each other. The processor 162 may include one or more processing units that perform various functions of the oversight server 160. The memory 168 may store any data and/or instructions used by the processor 162 to perform its functions. For example, the memory 168 may store software instructions 170 that when executed by the processor 162 cause the oversight server 160 to perform one or more functions described herein. The oversight server 160 may be configured as shown or in any other suitable configuration.

In one embodiment, the oversight server 160 may be implemented by a cluster of computing devices that may serve to oversee the operations of the autonomous vehicle 802. For example, the oversight server 160 may be implemented by a plurality of computing devices using distributed computing and/or cloud computing systems. In another example, the oversight server 160 may be implemented by a plurality of computing devices in one or more data centers. As such, in one embodiment, the oversight server 160 may include more processing power than the control device 850. The oversight server 160 is in signal communication with the autonomous vehicle 802 and its components (e.g., the control device 850).

Processor 162 comprises one or more processors. The processor 162 may be any electronic circuitry, including state machines, one or more CPU chips, logic units, cores (e.g., a multi-core processor), FPGAs, ASICs, or DSPs. The processor 162 may be a programmable logic device, a microcontroller, a microprocessor, or any suitable combination of the preceding. The processor 162 may be communicatively coupled to and in signal communication with the network interface 164, user interface 165, and memory 168. The one or more processors are configured to process data and may be implemented in hardware or software. For example, the processor 162 may be 8-bit, 16-bit, 32-bit, 64-bit or of any other suitable architecture. The processor 162 may include an ALU (arithmetic-logic unit) for performing arithmetic and logic operations, processor registers that supply operands to the ALU and store the results of ALU operations, and a control unit that fetches instructions from memory and executes them by directing the coordinated operations of the ALU, registers and other components. The one or more processors are configured to implement various instructions. For example, the one or more processors are configured to execute software instructions 170 to implement the functions disclosed herein, such as some or all of those described with respect to FIGS. 1-10. In some embodiments, the function described herein may be implemented using logic units, FPGAs, ASICs, DSPs, or any other suitable hardware or electronic circuitry.

Network interface 164 may be configured to enable wired and/or wireless communications of the oversight server 160. The network interface 164 may be configured to communicate data between the oversight server 160 and other devices, servers, autonomous vehicles 802, systems, or domains. For example, the network interface 164 may comprise an NFC interface, a Bluetooth interface, a Zigbee interface, a Z-wave interface, an RFID interface, a WIFI interface, a LAN interface, a WAN interface, a PAN interface, a modem, a switch, and/or a router. The processor 162 may be configured to send and receive data using the network interface 164. The network interface 164 may be configured to use any suitable type of communication protocol as would be appreciated by one of ordinary skill in the art.

User interfaces 165 may include one or more user interfaces that are configured to interact with users, such as the remote operator 184. The remote operator 184 may access the oversight server 160 via the communication path 186. In certain embodiments, the user interfaces 165 may include peripherals of the oversight server 160, such as monitors, keyboards, mouse, trackpads, touchpads, microphones, webcams, speakers, and the like. In certain embodiments, the user interface 165 may include a graphical user interface, a software application, or a web application. The remote operator 184 may use the user interfaces 165 to access the memory 168 to review any data stored in the memory 168. The remote operator 184 may confirm, update, and/or override the routing plan 136 and/or any other data stored in memory 168.

Memory 168 may be volatile or non-volatile and may comprise ROM, RAM, TCAM, DRAM, and SRAM. The memory 168 may include one or more of a local database, cloud database, NAS, etc. Memory 168 may store any of the information described in FIGS. 1-10 along with any other data, instructions, logic, rules, or code operable to implement the function(s) described herein when executed by processor 162. For example, the memory 168 may store software instructions 170, sensor data 130, object detection machine learning module 132, map data 134, routing plan 136, driving instructions 138, instructions 172, proposed trajectory 480, 476, module for confirming the hand signal detection 472, module for confirming trajectory plan 474, and/or any other data/instructions. The software instructions 170 may include code that when executed by the processor 162 causes the oversight server 160 to perform one or more functions described herein, such as some or all of those described in FIGS. 1-10. The memory 168 comprises one or more disks, tape drives, or solid-state drives, and may be used as an over-flow data storage device, to store programs when such programs are selected for execution, and to store instructions and data that are read during program execution.

Module for confirming the hand signal detection 472 may be implemented by a processor 162 executing software instructions 170, and is generally configured to confirm whether a hand signal 104 (or a hand-held sign 104) is in use and its interpretation. In certain embodiments, the module for confirming the hand signal detection 472 may be implemented by a neural network, convolutional neural network, and the like. In certain embodiments, the module for confirming the hand signal detection 472 may be implemented by cloud computing using distributed computer systems. Therefore, in certain embodiments, the module for confirming the hand signal detection 472 may have more accuracy than the hand signal detection module 140 onboard in an autonomous vehicle 802.

Module for confirming trajectory plan 474 may be implemented by a processor 162 executing software instructions 170, and is generally configured to confirm whether a trajectory brings an autonomous vehicle 802 out of the operational design domain 144 (e.g., whether the autonomous vehicle 802 can be navigated according to the trajectory autonomously). In certain embodiments, the module for confirming trajectory plan 474 may be implemented by a neural network, convolutional neural network, and the like. In certain embodiments, the module for confirming trajectory plan 474 may be implemented by cloud computing using distributed computer systems. Therefore, in certain embodiments, the module for confirming trajectory plan 474 may have more accuracy than the planning module 962 (see FIG. 9) and/or the hand signal detection module 140 onboard in an autonomous vehicle 802.

### Application Server

The application server 180 may be any computing device configured to communicate with other devices, such as the oversight server 160, autonomous vehicles 802, databases, etc., via the network 110. The application server 180 may be configured to perform functions described herein and interact with the remote operator 184, e.g., via communication path 182 using its user interfaces. Examples of the application server 180 include, but are not limited to, desktop computers, laptop computers, servers, etc. In one example, the application server 180 may act as a presentation layer from which the remote operator 184 can access the oversight server 160. As such, the oversight server 160 may send the routing plan 136, sensor data 130, instructions 172, proposed trajectory 480, 476, and/or any other data/instructions to the application server 180, e.g., via the network 110. The remote operator 184, after establishing the communication path 182 with the application server 180, may review the received data and confirm, update, and/or override any of the instructions 172, proposed trajectory 480, 476, for example.

The remote operator 184 may be an individual who is associated with and has access to the oversight server 160. For example, the remote operator 184 may be an administrator that can access and view the information regarding the autonomous vehicle 802, such as sensor data 130, driving instructions 138, routing plan 136, instructions 172, proposed trajectory 480, 476, and other information that is available on the memory 168. In one example, the remote operator 184 may access the oversight server 160 from the application server 180 that is acting as a presentation layer via the network 110.

### Example Flow Diagram for Operation of an Autonomous Vehicle When Hand Signals Are In Use

FIG. 2 illustrates an example flow diagram for operation of an autonomous vehicle 802 (see FIGS. 1 and 8) safely when hand signals and/or hand held signs 104 (see FIG. 1) are in use. Although this figure depicts functional operations in a particular order for purposes of illustration, the process is not limited to any particular order or arrangement of operations. One skilled in the relevant art will appreciate that the various operations portrayed in this figure could be omitted, rearranged, combined and/or adapted in various ways.

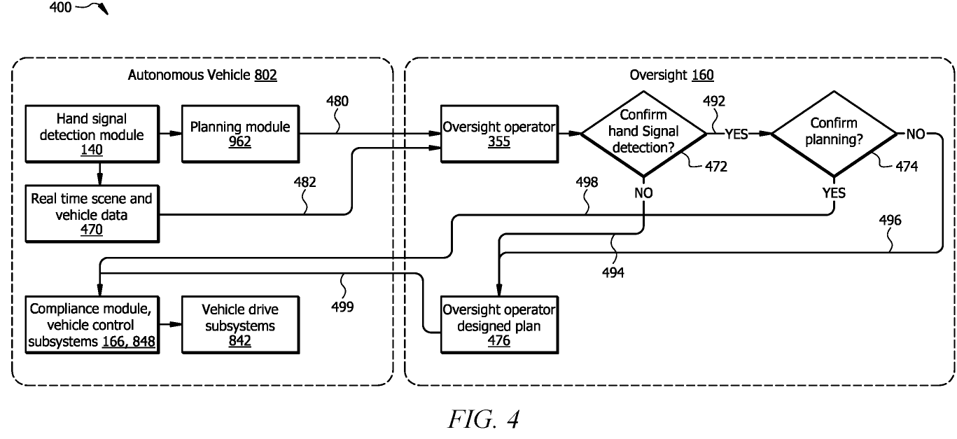

As shown in FIG. 2, the vehicle sensor subsystem 844 receives visual, auditory, or both visual and auditory signals indicating the at the environmental condition of the autonomous vehicle (802 in FIG. 8), as well as vehicle health or sensor activity data (e.g., sensor data 130 of FIG. 1) are received in operation 202. These visual and/or auditory signal data are transmitted from the vehicle sensor subsystem 844 to the control device 850, as in operation 204. The hand signal detection module (140 in FIG. 1) receives the data transmitted from the vehicle sensor subsystem 844, in operation 206. Then, that hand signal detection module (140 in FIG. 1) determines that hand signals or a hand-held sign is in use and that an actionable maneuver is required in operation 208. The information indicating that a change to the course of the autonomous vehicle is needed may include detection of hand signals from a pedestrian, detection of a hand-held sign (e.g., stop, slow), detection of an oscillating flashlight (e.g., a flashlight waved by a pedestrian to indicate a flow of traffic), or detection of other indicators that a human is signaling the autonomous vehicle while standing in or beside the roadway. Alternatively, as will be detailed in FIG. 4, the hand signal detection module may send information to the oversight system (160 in FIG. 1) or command center for review by computing facilities at the oversight system or command center or an operator (184 in FIG. 1) at the oversight system/command center. This information indicating that a change to the autonomous vehicle’s course of action is needed may be used by the compliance module (166 in FIG. 1) to formulate a new course of action to be taken that accounts for the use of hand signals or hand-held signs, in operation 210. The course of action to be taken may include slowing, stopping, moving into a shoulder, changing route, changing lane while staying on the same general route, and the like. The course of action to be taken may include initiating communications with any oversight or human interaction systems present on the autonomous vehicle. The course of action to be taken may then be transmitted from the control device 850 to the autonomous control system, in operation 212. The vehicle control subsystems 848 then cause the autonomous vehicle 802 (see FIGS. 1 and 8) to operate in accordance with the course of action to be taken that was received from the control device 850 in operation 214.

It should be understood that the specific order or hierarchy of operations in the processes disclosed herein is an example of exemplary approaches. Based upon design preferences, it is understood that the specific order or hierarchy of operations in the processes may be rearranged while remaining within the scope of the present disclosure. The accompanying method claims present elements of the various operations in a sample order and are not meant to be limited to the specific order or hierarchy presented.

### Autonomous Vehicle Oversight System

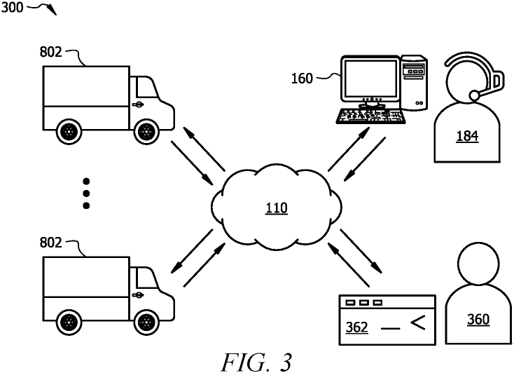

FIG. 3 illustrates an embodiment of system 300 that is configured for implementing communication between autonomous vehicles 802, an oversight server 160, and a third party 360. In the illustrated embodiments, system 300 includes one or more autonomous vehicles 802, a control center or oversight system 160 with a human operator 184, and an interface 362 for third-party 360 interaction. A human operator 184 may also be known as a remoter center operator (RCO) described in FIG. 1. Communications between the autonomous vehicles 802, oversight system 160 and user interface 362 take place over the network 110. In some instances, where not all the autonomous vehicles 802 in a fleet are able to communicate with the oversight system 160, the autonomous vehicles 802 may communicate with each other over the network 110 or directly. As described with respect to FIG. 8, the control device 850 of each autonomous vehicle 802 may include a network communication subsystem 892 for data transmission with other devices, systems, etc.

An autonomous vehicle 802 may be in communication with an oversight system 160. The oversight system 160 may serve many purposes, including: determining the use of hand signals or hand-held signs to direct traffic; the presence of a human using hand signals or a hand-held sign; determining action to be taken in response to the use of hand signals or a hand-held sign; instructing the autonomous vehicle 802 to perform a minimal risk condition (MRC) maneuver, and the like.

To allow for communication between autonomous vehicles 802 in a fleet and an oversight system 160 or command center, each autonomous vehicle 802 may be equipped with a communication gateway. The communication gateway may have the ability to do any of the following: allow for autonomous vehicle to oversight system communication (i.e. V2C) and the oversight system to autonomous vehicle communication (C2V); allow for autonomous vehicle to autonomous vehicle communication within the fleet (V2V); transmit the availability or status of the communication gateway; acknowledge received communications; ensure security around remote commands between the autonomous vehicle 802 and the oversight system 160; convey the autonomous vehicle’s location reliably at set time intervals; enable the oversight system 160 to ping the autonomous vehicle 802 for location and vehicle health status; allow for streaming of various sensor data directly to the command or oversight system 160; allow for automated alerts between the autonomous vehicle 802 and oversight system 160; comply to ISO 21434 standards; and the like.

An oversight system 160 or command center may be operated by one or more human, also known as an operator or a remote operator 184. The remote operator 184may review data provided by one or more autonomous vehicles 802 in contact with the oversight system 160 of command center. In response to the data provided by an autonomous vehicle 802, a remote operator 184 may review the data and send commands to the autonomous vehicle 802 or send information to third parties, such as law enforcement, service providers (e.g., truck repair personnel, tow-truck operator), a customer, and the like. Within the oversight system 160 of command center, there may be one or more computing modules to which the data from autonomous vehicles 802 may be passed for processing. Alternatively, or additionally, the remote operator 184 may undergo multiple operations to determine which types of commands, instructions, or information should be passed back to an autonomous vehicle 802. The data provided by one or more autonomous vehicle 802 may include any of: camera video, camera image data, LIDAR cloud data, or other data that indicates the use of hand signals or hand-held signs as well as information about the traffic flow and road conditions surrounding the one or more autonomous vehicles 802.

An oversight system 160 or command center may allow a third party 360 to interact with the oversight system operator 184, with an autonomous vehicle 802, or with both the operator 184 and an autonomous vehicle 802. A third party 360 may be a customer whose goods are being transported, a law enforcement or emergency services provider, or a person assisting the autonomous vehicle 802 when service is needed. In its interaction with a third party 360, the oversight system 160 may recognize different levels of access, such that a customer concerned about the timing or progress of a shipment may only be allowed to view status updates for an autonomous vehicle 802 or may be able to view status and provide input regarding what parameters to prioritize (e.g., speed, economy, maintaining originally planned route) to the oversight system 160. By providing input regarding parameter prioritization to the oversight system 160, a customer can influence the route and/or operating parameters of the autonomous vehicle 802. The remote operator 184 can have specific credentials or have the ability to verify the credentials of third parties (e.g., law enforcement) who may have access to camera views from the autonomous vehicle, including those of surroundings and of the inside of a cabin of an autonomous vehicle 802.

In certain embodiments, a system may include some or all of the components of the system 100 (see FIG. 1) and the system 300. For example, system 100 (see FIG. 1) may include the third party 360, and operations described with respect to system 300 may be performed by the system 100 of FIG. 1.

### Features of a System That Identifies Hand Signals by Pedestrian

FIG. 4 illustrates an embodiment of a data flow in a system between an autonomous vehicle 802 and an oversight system 160 (i.e., control center). The autonomous vehicle 802 may include multiple subsystems, as described in FIG. 8. With respect to FIG. 4, the autonomous vehicle 802 includes a hand signal detection module 140, a planning module 962, a vehicle control subsystem, a compliance module 166, vehicle drive subsystems 842 (e.g., a vehicle actuation module), and vehicle sensor subsystems 844 (in FIG. 8). On the autonomous vehicle 802, the vehicle sensor subsystems provide sensor data (130 in FIG. 1) to the hand signal detection module 140, such as a camera image, a camera video clip, and any sensor data that can indicate the use of hand signals or a hand-held sign to direct traffic.

The oversight system 160 may include multiple components for communicating with autonomous vehicles 802, and possibly third parties, as well as for receiving information from other data sources (e.g., law enforcement information, traffic information servers, weather service). An operator or a remote center operator 184 may be part of the oversight system 160. The operator 184 may review data from one or more autonomous vehicles 802, including data that cannot be confidently analyzed by the control device (850 in FIG. 1). In addition to communications modules and an operator, the oversight system 160 may include a module for confirming hand signal detection 472, a module to confirm planning 474 (e.g., a change in trajectory, the need for a minimal risk condition maneuver), and a module that complies and oversight operator designed plan for passing to one or more autonomous vehicles 802.

In some implementations, data may be passed and processed in a system that includes an autonomous vehicle 802 and an oversight system 160 that is capable of recognizing, and reacting appropriately to, the use of hand signals or a hand-held sign to direct vehicular traffic, as shown in FIG. 4. Sensor data (130 in FIG. 1) may be received by the hand signal detection module 140 which will detect and classify hand signals and hand-held signs, e.g., reroute, stop, proceed slowly, proceed slowly out of lane. The hand signal detection module 140 then passes data to the planning module 962 which creates an updated (or proposed) trajectory plan 480 in response to the type of hand signal or hand-held sign identified by the hand signal detection module 140. The updated trajectory plan 480 is passed to the oversight system 160. The hand signal detection module 140 also creates a real-time scene and vehicle data packet 470 that is passed via a priority communication link 482 to the oversight system 160 when the planning module 962 creates the updated trajectory plan 480. The vehicle data packet 470 may include health data related to components of the autonomous vehicle 802, sensor data (130 in FIG. 1), and/or any other data. The priority communication link 482 may be a high priority link, including a highest priority link, triggered by the detection of hand signals or hand-held sign use. The oversight system 160 may present the updated trajectory plan 480 and the vehicle data packet 470 to the oversight operator (RCO) 184 for review.

Hand signals (104 in FIG. 1) may include hands held up in a manner that indicates that traffic should stop, waving that indicates that traffic should commence and keep moving, hand motions that indicate a change in direction of traffic, and the like. Hand-held signs (104 in FIG. 1) may include those with words such as “stop” and “slow”, or may include lighted implements, particularly at night. Lighted implements may include lighted wands or flashlights (i.e., torches) of various colors (e.g., white, yellow, orange) to indicate a change in traffic flow. Flags may also be used and considered as an alternative implement when discussing hand-held signs. Flags may include colored flags to direct the flow of traffic or patterned flags to indicate road conditions, such a closed road. In some instances, the hand signals may originate from a driver of another vehicle or a bicycle, used in lieu of or in addition to lighted signals.

The oversight operator 184 may then indicate 472 via a human-interface of the oversight system 160 that “yes” 492 hand signals or hand-help signs are in use or “no” 494 that hand signals or hand-held signs are not being used to direct vehicular traffic. Confirmation 492 of the use of hand signals that the proposed updated trajectory plan created by the autonomous vehicle 802 is an appropriate response to the hand signals or a hand-held sign may be sent to compliance module 166 and vehicle control subsystems 848 on the autonomous vehicle 802, where the proposed updated trajectory plan 480 created by the autonomous vehicle 802 of hand signals or hand-held signs may be confirmed planning 474. That is to say, a module 474 to confirm updates to trajectory or instructions to perform a minimal risk condition maneuver and the compliance module 166 and vehicle control subsystems 848 on the autonomous vehicle 802 execute the updated trajectory plan 480 via the vehicle drive subsystems 842.

When it is determined that hand signals or hand-held signs are being used to direct vehicular traffic and that the proposed updated trajectory plan 480 is appropriate, the oversight operator 184 may transmit an acknowledgement 498 indicating to navigate the autonomous vehicle 802 according to the planned trajectory 480 to the compliance module 166 and vehicle control subsystems 848. When it is determined hand signals or hand-held signs are not being used to direct vehicular traffic 494 or that the proposed updated trajectory plan 480 is not appropriate 496, the oversight operator 184 may formulate an appropriate trajectory plan 476 for the autonomous vehicle 802. The trajectory plan 476 may be passed 499 to the compliance module 166 and vehicle control subsystems 848 on the autonomous vehicle 802 and this trajectory plan 476 can be executed by the vehicle drive subsystems 842. The oversight system 160, (e.g., via an automated system and/or the operator 184), will continue to monitor the autonomous vehicle 802, particularly during navigation through an area where traffic is directed by hand signals or hand-held signs. Once the autonomous vehicle 802 has safely traveled through the area where traffic is directed by a pedestrian using hand signals or hand-held signs, the oversight operator 184 may be able to close the priority communication link 482 that provides real-time scene and vehicle data 470. Additionally, the autonomous vehicle 802 may be able to analyze and communicate with the oversight system operator 184 when planned actions or trajectory created by any of the autonomous vehicle 802, remote operator 184, and/or the oversight server 160 may cause the autonomous vehicle 802 to be outside of its operational design domain (e.g., go off-map, outside of a geofenced or previously mapped area). Further, in some instances, the oversight operator 184 may be versed in regional/jurisdictional differences in hand signals or hand-held signs, and the operator 184 will be able to instruct the autonomous vehicle 802 appropriately.

Sensors and systems on the autonomous vehicle 802 may work with an oversight system 160 to confirm the analysis by the autonomous vehicle 802 that hand signals are in use and to confirm that the trajectory updates (e.g., trajectory 480) proposed by the autonomous vehicle 802 are appropriate, as described above. The appropriateness of a trajectory update may be compared to an operational design domain (ODD) (146 in FIG. 1) or information provided to the autonomous vehicle 802 or oversight system 160 by external sources. Information about locations provided by systems, such as mapping systems or traffic updates, may indicate areas where hand signals are likely to be used, such as crossings near schools, construction areas, and areas near traffic incidents. For example, areas near schools may be known to have crosswalks that are tended by a crossing guard that uses a hand-held sign or hand signals to stop traffic while children cross the street. Such areas may be noted in the hand signal detection module 140 so that sensor data (130 in FIG. 1) in these areas will be more carefully examined for hand signal use. In some cases, the use of hand signals or hand-held signs to direct traffic in an area may be dependent not only on location but also on the time of day, such as a construction site that is active only between 11PM and 5AM or a school that expects student crossings only twice a day for hour-long periods.

Actions that an autonomous vehicle 802, particularly an autonomous truck, as described herein may be configured to execute to safely traverse a course while abiding by the applicable rules, laws, and regulations may include those actions successfully accomplished by an autonomous truck driven by a human. These actions, or maneuvers, may be described as features of the autonomous vehicle 802, in that these actions may be executable programming stored on the control device (850 in FIG. 1). These actions or features may include those related to reactions to the detection of certain types of conditions or objects such as: appropriate motion in response to detection of an emergency vehicle with flashing lights; appropriate motion in response to detecting one or more vehicles approaching the autonomous vehicle 802, motions or actions in response to encountering an intersection; execution of a merge into traffic in an adjacent lane or area of traffic; detection of need to clean one or more sensor and the cleaning of the appropriate sensor; and the like. Other features of an autonomous vehicle 802 may include those actions or features which are needed for any type of maneuvering, including that needed to accomplish the features or actions that are reactionary, listed above. Such features, which may be considered supporting features, may include: the ability to maintain an appropriate following distance; the ability to turn right and left with appropriate signaling and motion, and the like. These supporting features, as well as the reactionary features listed above, may include controlling or altering the steering, engine power output, brakes, or other vehicle control subsystems 848 (see FIG. 8).

Systems and methods are described herein that allow an autonomous vehicle 802 to navigate from a first point to a second point without a human driver present in the autonomous vehicle 802 and to comply with instructions for safe and lawful operation including instructions given through hand signals or hand-held signs. Though aspects of analysis are described as being performed on an autonomous vehicle 802, these may be performed by an oversight system 160 or a remote computing facility. Conversely, or additionally, aspects that are described as being performed by an oversight system or operator 184, these may be performed by an autonomous driving system on an autonomous vehicle 802 including on an autonomous vehicle 802 other than the autonomous vehicle 802 detecting an environment or area where hand signals are used to direct traffic.

### Example Method for Navigation According to a Hand Signal

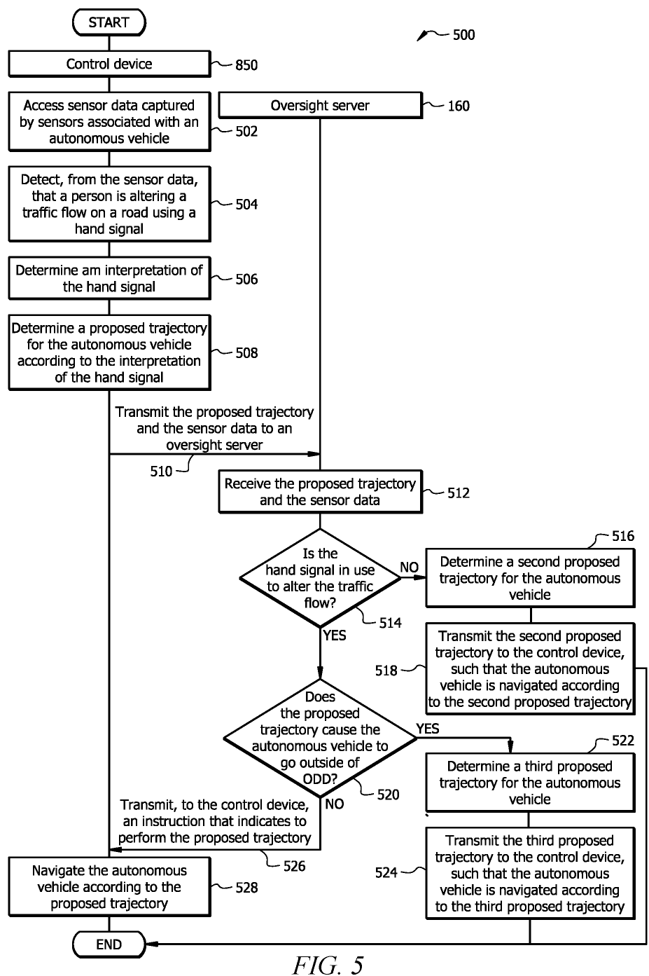

FIG. 5 illustrates an example flowchart of a method 500 for autonomous vehicle navigation according to a hand signal 104. Modifications, additions, or omissions may be made to method 500. Method 500 may include more, fewer, or other operations. For example, operations may be performed in parallel or in any suitable order. While at times discussed as the system 100, autonomous vehicle 802, control device 850, oversight server 160, or components of any of thereof performing operations, any suitable system or components of the system may perform one or more operations of the method 500. For example, one or more operations of method 500 may be implemented, at least in part, in the form of software instructions 128, software instructions 170, and processing instructions 880, respectively, from FIGS. 1 and 8, stored on non-transitory, tangible, machine-readable media (e.g., memory 126, memory 168, and data storage 890, respectively, from FIGS. 1 and 8) that when run by one or more processors (e.g., processors 122, 162, and 870, respectively, from FIGS. 1 and 8) may cause the one or more processors to perform operations 502-528.

At operation 502, the control device 850 accesses sensor data 130 captured by sensors 846 associated with an autonomous vehicle 802. For example, while the autonomous vehicle 802 is traveling along a road 102, the sensors 846 capture sensor data 130 and transmit the sensor data 130 to the control device 850.

At operation 504, the control device 850 detects, from the sensor data 130, that a person 106 is altering traffic flow on the road 102 using a hand signal 104. For example, the control device 850 may feed the sensor data 130 to the object detection machine learning module 132 and/or the hand signal detection module 140 to determine objects (e.g., the person 106, flag held by the person 106, traffic sign, hand-held sign, etc.) on the road 102 and determine whether a hand signal 104 (and/or a hand-held sign 104) is being used to direct traffic, similar to that described in FIGS. 1-4.

At operation 506, the control device 850 determines an interpretation of the hand signal 104. In this process, the control device 850 may access a training dataset comprising a plurality of data samples, such as images, videos, LiDAR data, Radar data, point cloud data, and any other data format. The description below describes using images of the training dataset. However, it is understood that any number and any combination of sample data formats may be used in determining the interpretation of the hand signal 104. Each of the sample data in the training dataset may be labeled with a respective hand signal. For example, with respect to the images in the training dataset, each respective image is labeled with an interpretation of a hand signal shown in the respective image. The control device 850 extracts a first set of features from the sensor data 130 where the hand signal 104 is detected (e.g., by the object detection machine learning module 132 and/or the hand signal detection module 140). The first set of features indicates a type of the hand signal 104. For example, the type of the hand signal 104 may be slow down, pull over, stop, change lane to right, change lane to left, or any suitable hand signal that may be used to direct traffic. The first set of features may be represented by a first vector comprising numerical values. The control device 850 may extract a second set of features from an image from images in the training dataset. Similarly, the control device 850 may extract features from each image (and/or other data samples) in the training dataset. The image may show a particular hand signal. The image may be labeled with a particular interpretation of the particular hand signal. The second set of features may indicate a type of the particular hand signal. The second set of features may be represented by a second vector comprising numerical values. The control device 850 may determine a distance between the first vector and the second vector. For example, the control device 850 may determine the Euclidian distance between the first and second vectors. In the same or another example, the control device 850 may determine a cosine similarity score between the first and second vectors. In response to determining that the distance between the first vector and the second vector is less than a threshold distance (e.g., less than 2%, 1%, etc.), the control device 850 may determine that the interpretation of the hand signal (detected from the sensor data) corresponds to the particular interpretation of the particular hand signal (shown in the image). Otherwise, the control device 850 may determine that the interpretation of the hand signal (detected from the sensor data) does not correspond to the particular interpretation of the particular hand signal (shown in the image). Similarly, if a hand-held sign 104 is detected, the control device 850 may perform similar operations to determine the interpretation of the hand-held sign 104.

At operation 508, the control device 850 determines a proposed trajectory 480 for the autonomous vehicle 802 according to the interpretation 146 of the hand signal 104. In certain embodiments, the proposed trajectory 480 may follow the interpretation 146 of the hand signal 104. For example, if the interpretation of the hand signal 104 is stop, the proposed trajectory 480 may be stopping the autonomous vehicle 802. In another example, if the interpretation of the hand signal 104 is slow down, the proposed trajectory 480 may be slowing down the autonomous vehicle 802. Other interpretations of hand signals 104 and respective proposed trajectories 480 are also contemplated, such as pull over, change lane, etc. The control device 850 may determine the proposed trajectory 480 by updating the routing plan 136. For example, the control device 850 may determine the proposed trajectory 480 by updating a turn-by-turn navigation of the autonomous vehicle 802.

At operation 510, the control device 850 transmits the proposed trajectory 480 and sensor data 130 to the oversight server 160. In certain embodiments, the control device 850 may also transmit the real-time scene and vehicle data 470 to the oversight server 160.

At operation 512, the oversight server 160 receives the proposed trajectory 480 and the sensor data 130. At operation 514, the oversight server 160 determines whether the hand signal 104 is in use to alter the traffic flow. The oversight server 160 may determine that the hand signal 104 is in use to alter the traffic flow based on one or more indications detected from the sensor data 130. For example, the oversight server 160 may determine that the hand signal 104 is in use to alter the traffic if the person 106 is facing oncoming traffic and performing the hand signal 104, and that the person 106 is wearing a construction uniform, a law enforcement uniform, a paramedic uniform, an emergency personnel uniform, and the like. The oversight server 160 may also determine that the person 106 is on a traffic lane or in a middle of an intersection. The oversight server 160 may also determine if the person 106 is near a construction zone 108 or a road anomaly 112. For example, the oversight server 160 may determine if the person 106 (and/or the autonomous vehicle 802) in an area that is known to be where hand signals 104 (or hand-held signs 104) are used to direct traffic, e.g., a construction zone, a road closure, a school zone, an area near a road accident, congested traffic, any other road anomaly, etc. The oversight server 160 may use this information as indication that the hand signal 104 may be in use to direct traffic. In certain embodiments, the oversight server 160 may perform the operations below to determine whether the hand signal 104 is in use to alter the traffic flow.

The oversight server 160 may access the map data 134 that comprises at least a portion of a map of a city that includes the road 102 traveled by the autonomous vehicle 802. The oversight server 160 may determine, from the map data 134, that the autonomous vehicle 802 is traveling within a particular area where is known hand signals 104 or hand-held signals 104 are used to control (e.g., alter, direct) traffic. The particular area may include a school road crossing area, a construction area, a road accident area, etc. The oversight server 160 may prioritize (over other sensor data 130 captured in other locations) the analysis of the sensor data 130 for hand signal detection (or hand-held sign detection) in such particular areas where the sensor data 130 is captured.

In certain embodiments, the oversight server 160 may prioritize the analysis of the sensor data 130 based on a time window when the sensor data 130 is captured. For example, the oversight server 160 may determine that the autonomous vehicle 802 is traveling within the particular area (described above) during a particular time window, such as active hours of a construction site, school opening hours, or school closing hours. The oversight server 160 may prioritize (over other sensor data 130 captured in other time windows) the analysis of the sensor data 130 for hand signal detection (or hand-held sign detection) in such time windows when the sensor data 130 is captured.

The oversight server 160 may be configured to differentiate between when an authorized person 106, such as a construction worker, a law enforcement officer, emergency personnel is performing the hand signal 104 or a bad actor is attempting to tamper with the autonomous vehicle 802 by performing the hand signal 104. For example, the oversight server 160 may implement a machine learning algorithm that is pre-trained to differentiate between when an authorized person 106 is performing the hand signal 104 to alter the traffic and a bad actor is attempting to tamper with the autonomous vehicle 802 by performing the hand signal 104.

Similarly, the oversight server 160 may determine that a hand-held sign 104 is in use to alter the traffic if the person 106 is facing oncoming traffic and holding the hand-held sign 104.

In certain embodiments, the control device 850 may be configured to perform one or more operations of the oversight server 160. If it is determined that the hand signal 104 is in use to alter traffic flow, method 500 proceeds to operation 520. Otherwise, method 500 proceeds to operation 516.

At operation 516, the oversight server 160 may determine a second proposed trajectory 476 for the autonomous vehicle 802. The second proposed trajectory 476 may be determined by the oversight server 160 based on analyzing the received data and executing a plurality of driving simulations for the autonomous vehicle 802. The remote operator 184 may update, confirm, or override the second proposed trajectory 476.

At operation 518, the oversight server 160 transmits the second proposed trajectory 476 to control device 850, such that the autonomous vehicle 802 is navigated according to the second proposed trajectory 476. For example, the control device 850 may receive the second proposed trajectory 476 and navigate the autonomous vehicle 802 according to the second proposed trajectory 476.

At operation 520, the oversight server 160 determines whether proposed trajectory 480 causes the autonomous vehicle 802 to go outside of operational design domain 144. For example, the operational design domain 144 may indicate previously-mapped geographical areas and locations where the autonomous vehicle 802 is able to autonomously travel - i.e., the control device 850 is able to confidently navigate the autonomous vehicle 802 autonomously. The previously-mapped geographical areas and locations may be indicated in the map data 134. If it is determined that the proposed trajectory 480 causes the autonomous vehicle 802 to go outside of the operational design domain 144, method 500 proceeds to operation 522. Otherwise, method 500 proceeds to operation 526.

At operation 522, the oversight server 160 determines a third proposed trajectory 476 for the autonomous vehicle 802. The third proposed trajectory 476 may be determined by the oversight server 160 based on analyzing the received data and executing a plurality of driving simulations for the autonomous vehicle 802. The remote operator 184 may update, confirm, or override the third proposed trajectory 476.

At operation 524, the oversight server 160 transmits the third proposed trajectory 476 to the control device 850, such that the autonomous vehicle 802 is navigated according to the third proposed trajectory 476. For example, the control device 850 may receive the third proposed trajectory 476 and navigate the autonomous vehicle 802 according to the third proposed trajectory 476.

At operation 526, the oversight server 160 transmits, to the control device 850, an instruction 172 that indicates to perform the proposed trajectory 480. At operation 528, the control device 850 navigates the autonomous vehicle 802 according to the proposed trajectory 480.

In certain embodiments, if the control device 850 determines that the proposed trajectory 480 causes the autonomous vehicle 802 to go outside of the operational design domain 144, the control device 850 may instruct the autonomous vehicle 802 to perform a minimal risk condition maneuver, such as pulling over, stopping, and the like. The control device 802 may inform the oversight server 160 whenever the minimal risk condition maneuver is performed. For example, the control device 850 may communicate a message indicating that the minimal risk condition maneuver is performed to the oversight server 160.

In certain embodiments, the control device 850 may transmit any of the proposed trajectories 480, 476 that is decided and finalized to one or more other autonomous vehicles 802, e.g., that are heading toward the location of the person 106 that is performing the hand signal 104 (or the hand-held sign 104) and that are within a threshold distance from the person 106 (or the lead autonomous vehicle 802), such as within a hundred feet, two hundred feet, or any other suitable distance.

In certain embodiments, the oversight server 160 may transmit any of the proposed trajectories 480, 476 that is decided and finalized to one or more other autonomous vehicles 802, e.g., that are heading toward the location of the person 106 that is performing the hand signal 104 (or the hand-held sign 104) and that are within the threshold distance from the person 106 (or the lead autonomous vehicle 802), such as within a hundred feet, two hundred feet, or any other suitable distance.

Although some operations of the method 500 are described to be performed by the control device 850, and other operations are described to be performed by the oversight server 160, the present disclosure contemplates other embodiments. In certain embodiments, all the operations of the method 500 may be performed by the oversight server 160. In certain embodiments, all the operations of the method 500 may be performed by the control device 850. For example, the control device 850 may perform the operations 502-508, and navigate the autonomous vehicle 802 according to the proposed trajectory 480. For example, the control device 850 may have full autonomy to perform these operations. In another example, the control device 850 may have a partial autonomy and may need a confirmation (e.g., instruction 172) or an updated trajectory (e.g., trajectory 476) from the oversight server 160.

In certain embodiments, the oversight server 160 may communicate the sensor data 130 and the proposed trajectory 480, 476 to a third party 360. The third party 360 may review the received data and provide input as to what driving and traveling parameters to be prioritized. The oversight server 160 may receive the input from the third party 360 regarding one or more driving and traveling parameters to prioritize, such as a speed, a fuel-saving parameter, or maintaining an originally planned route (e.g., the routing plan 136). The oversight server 160 may update the proposed trajectory 480, 476 based on the received input and transmit the updated trajectory 480, 476 to the control device 850 for the autonomous vehicle navigation.

### Example Method for Navigation According to a Construction Zone Hand Signal

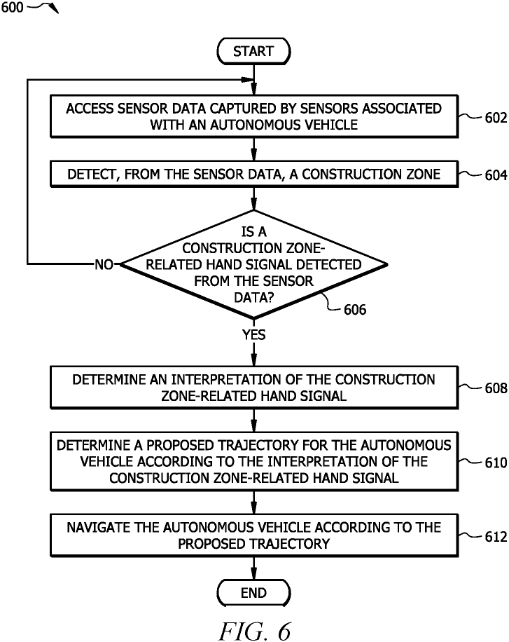

FIG. 6 illustrates an example flowchart of a method 600 for autonomous vehicle navigation according to a construction zone hand signal 104. Modifications, additions, or omissions may be made to method 600. Method 600 may include more, fewer, or other operations. For example, operations may be performed in parallel or in any suitable order. While at times discussed as the system 100, autonomous vehicle 802, control device 850, oversight server 160, or components of any of thereof performing operations, any suitable system or components of the system may perform one or more operations of the method 600. For example, one or more operations of method 600 may be implemented, at least in part, in the form of software instructions 128, software instructions 170, and processing instructions 880, respectively, from FIGS. 1 and 8, stored on non-transitory, tangible, machine-readable media (e.g., memory 126, memory 168, and data storage 890, respectively, from FIGS. 1 and 8) that when run by one or more processors (e.g., processors 122, 162, and 870, respectively, from FIGS. 1 and 8) may cause the one or more processors to perform operations 602-612.

At operation 602, the control device 850 accesses sensor data 130 captured by sensors 846 associated with an autonomous vehicle 802, similar to that described in FIGS. 1-5.

At operation 604, the control device 850 detects, from the sensor data 130, a construction zone 108. The control device 850 may detect indications of a construction zone 108 from the sensor data 130 by feeding the sensor data 130 to the object detection machine learning module 132, extracting a set of features from the sensor data 130, where the set of features may indicate physical attributes of objects indicated in the sensor data 130, such as shapes, sizes, colors, locations, movements, identifiers etc. The control device 850 may determine that the objects include at least one of a piece of construction equipment, a traffic cone, a traffic barrier, a construction worker 106, and/or any other object associated with a construction zone 108.

At operation 606, the control device 850 determines whether a construction zone-related hand signal 104 detected from the sensor data 130. Examples of the construction zone-related hand signal 104 may include any of the hand signals 104 described herein. The control device 850 may determine whether the construction zone-related hand signal 104 is detected by feeding the sensor data 130 to the hand signal detection module 140 and/or the object detection machine learning module 132, similar to that described in FIGS. 1-5.

For example, the control device 850 may determine that a construction worker 106 is altering the traffic flow using the construction zone-related hand signal 104 (and/or a construction zone-related hand-held sign 104), where the construction worker 106 is on a traffic lane adjacent to the construction zone 108 (e.g., within a threshold distance, for example within ten feet, eight feet, etc.) and facing oncoming traffic. In certain embodiments, the detection of the construction zone-related hand signal 104 and/or the person is a construction worker 106 may include determining that the construction worker 106 is wearing a construction uniform. If it is determined that the construction zone-related hand signal 104 is detected, method 600 proceeds to operation 608. Otherwise, method 600 returns to operation 602.

At operation 608, the control device 850 determines an interpretation 146 of the construction zone-related hand signal 104. For example, the control device 850 may perform operations described in operation 506 of FIG. 5, in a case where a hand signal 104 is a construction zone-related hand signal 104. Likewise, the control device 850 may perform similar operations in a case where a construction zone-related hand-held sign 104 is detected.

At operation 610, the control device 850 determines a proposed trajectory 480 for the autonomous vehicle 802 according to the interpretation 146 of the construction zone-related hand signal 104. The control device 850 may determine the proposed trajectory 480 similar to that described in operation 510 of FIG. 5. The proposed trajectory 480 may follow the interpretation 146 of the construction zone-related hand signal 104. For example, if the interpretation 146 of the construction zone-related hand signal 104 is to proceed forward, the proposed trajectory 480 may be moving forward. In another example, if the interpretation 146 of the construction zone-related hand signal 104 is to slow down, the proposed trajectory 480 may be slowing down.

At operation 612, the control device 850 navigates the autonomous vehicle 802 according to the proposed trajectory 480. In certain embodiments, the control device 850 and the oversight server 160 may perform similar operations in a case where a construction zone-related hand-held sign 104 is detected from the sensor data 130, similar to that described in FIG. 5.

In certain embodiments, the control device 850 and the oversight server 160 may perform similar operations in a case where a construction zone-related hand-held sign 104 is detected from the sensor data 130, similar to that described in FIG. 5.

In certain embodiments, the control device 850 and the oversight server 160 may perform operations, similar to that described in FIG. 5. For example, in response to determinizing the proposed trajectory 480 at operation 610, the control device 850 may transmit the interpretation 146 of the construction zone-related hand signal 104 and the proposed trajectory 480 to the oversight server 160. The oversight server 160 may receive the transmitted data and determine whether the construction zone-related hand signal 104 is in use to alter the traffic flow, similar to that described in operation 514 of FIG. 5. If it is determined that the construction zone-related hand signal 104 is in use to alter the traffic flow, the oversight server may determine whether the proposed trajectory 480 causes the autonomous vehicle 802 to go outside of the operational design domain 144. If it is determined that the proposed trajectory 480 does not cause the autonomous vehicle 802 to go outside of the operational design domain 144, the oversight server 160 may transmit the instructions 172 to the control device 850, where the instructions 172 indicate to perform the proposed trajectory 480. The control device 850 may receive the instructions 172 and navigate the autonomous vehicle 802 according to the proposed trajectory 480.

In certain embodiments, if the oversight server 160 determines that the construction zone-related hand signal 104 is not in use to alter traffic, the oversight server 160 may determine a second proposed trajectory 476 for the autonomous vehicle 802 and transmit the second proposed trajectory 476 to the control device 850. The control device 480 may receive the second proposed trajectory 476 and navigate the autonomous vehicle 802 according to the second proposed trajectory 476.

In certain embodiments, if the oversight server 160 determines that the proposed trajectory 480 causes the autonomous vehicle 802 to go outside of the operational design domain 144, the oversight server 160 may determine a third proposed trajectory 476 for the autonomous vehicle 802 and transmit the third proposed trajectory 476 to the control device 850. The control device 480 may receive the third proposed trajectory 476 and navigate the autonomous vehicle 802 according to the third proposed trajectory 476.

In certain embodiments, the oversight server 160 may transmit the finalized proposed trajectory 480, 476 to one or more other autonomous vehicles 802, e.g., that are heading toward the road anomaly 112, similar to that described in FIG. 5.

In certain embodiments, one or both of the control device 850 and the oversight server 160 may determine whether the construction zone-related hand signal 104 is in use to alter the traffic flow.

In certain embodiments, determining whether the construction zone-related hand signal 104 is in use to alter the traffic flow may comprise accessing map data 134, determining, from the map data 134, that the autonomous vehicle 802 is traveling within a particular area where is known hand signals 104 are used to control traffic, where the particular area comprises a construction area, and prioritizing an analysis of the sensor data 130 for hand signal detection, where the sensor data 130 is captured when the autonomous vehicle 802 is traveling within the particular area, similar to that described in FIG. 5.

In certain embodiments, determining whether the construction zone-related hand signal 104 is in use to alter the traffic flow may comprise determining that the autonomous vehicle 802 is traveling within the particular area during a particular time window, where the particular time window comprises active hours of a construction site, and prioritizing an analysis of the sensor data 130 for hand signal detection, where the sensor data 130 is captured during the particular time window, similar to that described in FIG. 5. Similarly, the oversight server 160 and/or the control device 850 may determine that a construction zone-related hand-held sign 104 is in use to alter the traffic if the construction worker106 is facing oncoming traffic and holding the construction zone-related hand-held sign 104.

In certain embodiments, the control device 850 and/or the oversight server 160 may determine whether a proposed trajectory 480, 476 causes the autonomous vehicle 802 to go outside of the operational design domain 144 and perform an appropriate action, similar to that described in FIGS. 1-5.

In certain embodiments, the oversight server 160 may communicate the sensor data 130 and the proposed trajectory 480, 476 to a third party 360 and receive input from the third party 360, similar to that described in FIG. 5. The oversight server 160 may update the proposed trajectory 480, 476 based on the received input and transmit the updated trajectory 480, 476 to the control device 850 for the autonomous vehicle navigation.

### Example Method For Navigation According to an Emergency Personnel Hand Signal

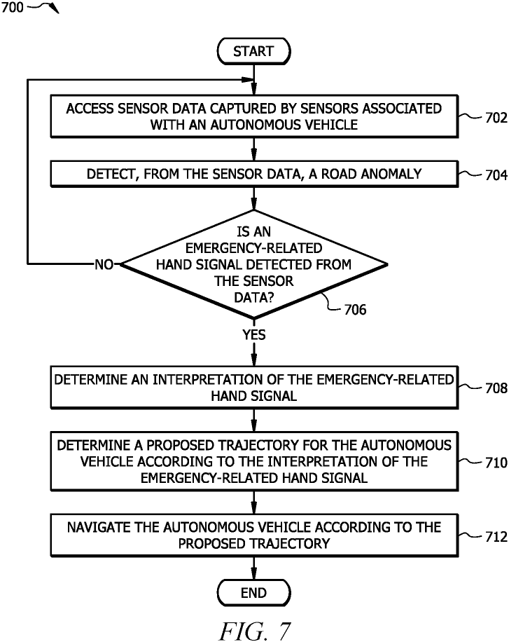

FIG. 7 illustrates an example flowchart of a method 700 for autonomous vehicle navigation according to an emergency-related hand signal 104. Modifications, additions, or omissions may be made to method 700. Method 700 may include more, fewer, or other operations. For example, operations may be performed in parallel or in any suitable order. While at times discussed as the system 100, autonomous vehicle 802, control device 850, oversight server 160, or components of any of thereof performing operations, any suitable system or components of the system may perform one or more operations of the method 700. For example, one or more operations of method 700 may be implemented, at least in part, in the form of software instructions 128, software instructions 170, and processing instructions 880, respectively, from FIGS. 1 and 8, stored on non-transitory, tangible, machine-readable media (e.g., memory 126, memory 168, and data storage 890, respectively, from FIGS. 1 and 8) that when run by one or more processors (e.g., processors 122, 162, and 870, respectively, from FIGS. 1 and 8) may cause the one or more processors to perform operations 702-612.

At operation 702, the control device 850 accesses sensor data 130 captured by sensors 846 associated with an autonomous vehicle 802, similar to that described in FIGS. 1-5.

At operation 704, the control device 850 detects, from the sensor data 130, a road anomaly 112. The road anomaly 112 may be a road accident, a road closure, congested traffic, etc. The control device 850 may detect indications of a road anomaly 112 from the sensor data 130 by feeding the sensor data 130 to the object detection machine learning module 132, extracting a set of features from the sensor data 130, where the set of features may indicate physical attributes of objects indicated in the sensor data 130, such as shapes, sizes, colors, locations, movements, identifiers, etc. The control device 850 may determine that the objects include any object associated with a road anomaly 112, such as a traffic cone, a traffic barrier, more than a threshold number of vehicles within a threshold area (i.e., congested traffic), a collision on a road, a stationary object on a road, etc.

At operation 706, the control device 850 determines whether an emergency-related hand signal 104 is detected from the sensor data 130. Examples of the emergency-related hand signal 104 may include any of the hand signals 104 described herein. The control device 850 may determine whether the emergency-related hand signal 104 is detected by feeding the sensor data 130 to the hand signal detection module 140 and/or the object detection machine learning module 132, similar to that described in FIGS. 1-5. For example, the control device 850 may determine that an emergency personnel 106 is altering the traffic flow using the emergency-related hand signal 104 (and/or an emergency-related hand-held sign 104), where the emergency personnel 106 is on a traffic lane adjacent to the road anomaly 112 (e.g., within a threshold distance, for example within ten feet, eight feet, etc.) and facing oncoming traffic. The emergency personnel 106 may be a law enforcement officer, a firefighter, or a paramedic, for example. In certain embodiments, the detection of the emergency-related hand signal 104 and/or the person is an emergency personnel 106 may include determining that the emergency personnel 106 is wearing a law enforcement uniform, a firefighter uniform, or a paramedic uniform. If it is determined that the emergency-related hand signal 104 is detected, method 700 proceeds to operation 708. Otherwise, method 700 returns to operation 702.

At operation 708, the control device 850 determines an interpretation 146 of the emergency-related hand signal 104. For example, the control device 850 may perform operations described in operation 506 of FIG. 5, in a case where a hand signal 104 is an emergency-related hand signal 104. Likewise, the control device 850 may perform similar operations in a case where an emergency-related hand-held sign 104 is detected.

At operation 710, the control device 850 determines a proposed trajectory 480 for the autonomous vehicle 802 according to the interpretation 146 of the emergency-related hand signal 104. The control device 850 may determine the proposed trajectory 480 similar to that described in operation 510 of FIG. 5. The proposed trajectory 480 may follow the interpretation 146 of the emergency-related hand signal 104. For example, if the interpretation 146 of the emergency-related hand signal 104 is to proceed forward, the proposed trajectory 480 may be moving forward. In another example, if the interpretation 146 of the emergency-related hand signal 104 is to slow down, the proposed trajectory 480 may be slowing down. In another example, the emergency-related hand signal 104 may be hand motions or waving a flag that indicates vehicles on right, front, and behind to stop, and vehicles on a left side to proceed. If the interpretation of the emergency-related hand signal 104 is vehicles on right, front, and behind of the emergency personnel 106 to stop, and vehicles on the left side to proceed, the proposed trajectory 480 may be moving forward if the autonomous vehicle 802 is on the left side of the emergency personnel 106, and the proposed trajectory 480 may be stopping if the autonomous vehicle 802 is on any of the right, front, and behind of the emergency personnel 106.

At operation 712, the control device 850 navigates the autonomous vehicle 802 according to the proposed trajectory 480. In certain embodiments, the control device 850 and the oversight server 160 may perform similar operations in a case where an emergency-related hand-held sign 104 is detected from the sensor data 130, similar to that described in FIG. 5. In certain embodiments, the control device 850 and the oversight server 160 may perform operations, similar to that described in FIG. 5. For example, in response to determinizing the proposed trajectory 480 at operation 710, the control device 850 may transmit the interpretation 146 of the emergency-related hand signal 104 and the proposed trajectory 480 to the oversight server 160. The oversight server 160 may receive the transmitted data and determine whether the emergency-related hand signal 104 is in use to alter the traffic flow, similar to that described in operation 514 of FIG. 5. If it is determined that the emergency-related hand signal 104 is in use to alter the traffic flow, the oversight server may determine whether the proposed trajectory 480 causes the autonomous vehicle 802 to go outside of the operational design domain 144. If it is determined that the proposed trajectory 480 does not cause the autonomous vehicle 802 to go outside of the operational design domain 144, the oversight server 160 may transmit the instructions 172 to the control device, where the instructions 172 indicate to perform the proposed trajectory 480. The control device 850 may receive the instructions 172 and navigate the autonomous vehicle 802 according to the proposed trajectory 480.

In certain embodiments, if the oversight server 160 determines that the emergency-related hand signal 104 is not in use to alter traffic, the oversight server 160 may determine a second proposed trajectory 476 for the autonomous vehicle 802 and transmit the second proposed trajectory 476 to the control device 480. The control device 480 may receive the second proposed trajectory 476 and navigate the autonomous vehicle 802 according to the second proposed trajectory 476.

In certain embodiments, if the oversight server 160 determines that the proposed trajectory 480 causes the autonomous vehicle 802 to go outside of the operational design domain 144, the oversight server 160 may determine a third proposed trajectory 476 for the autonomous vehicle 802 and transmit the third proposed trajectory 476 to the control device 850. The control device 480 may receive the third proposed trajectory 476 and navigate the autonomous vehicle 802 according to the third proposed trajectory 476.

In certain embodiments, the oversight server 160 may transmit the finalized proposed trajectory 480, 476 to one or more other autonomous vehicles 802, e.g., that are heading toward the road anomaly 112, similar to that described in FIG. 5. In certain embodiments, one or both of the control device 850 and the oversight server 160 may determine whether the emergency-related hand signal 104 is in use to alter the traffic flow.

In certain embodiments, determining whether the emergency-related hand signal 104 is in use to alter the traffic flow may comprise accessing map data 134, determining, from the map data 134, that the autonomous vehicle 802 is traveling within a particular area where is known hand signals 104 are used to control traffic, where the particular area comprises one of a school road crossing area, a construction area, or a road accident area, and prioritizing an analysis of the sensor data 130 for hand signal detection, where the sensor data 130 is captured when the autonomous vehicle 802 is traveling within the particular area (e.g., a road accident, congested traffic, etc.), similar to that described in FIG. 5.

In certain embodiments, determining whether the emergency-related hand signal 104 is in use to alter the traffic flow may comprise determining that the autonomous vehicle 802 is traveling within the particular area during a particular time window, where the particular time window comprises one of active hours of a construction site, school opening hours, or school closing hours, and prioritizing an analysis of the sensor data 130 for hand signal detection, where the sensor data 130 is captured during the particular time window, similar to that described in FIG. 5. Similarly, the oversight server 160 and/or the control device 850 may determine that an emergency-related hand-held sign 104 is in use to alter the traffic if the emergency personnel 106 is facing oncoming traffic and holding the emergency-related hand-held sign 104.

In certain embodiments, the control device 850 and/or the oversight server 160 may determine whether a proposed trajectory 480, 476 causes the autonomous vehicle 802 to go outside of the operational design domain 144 and perform an appropriate action, similar to that described in FIGS. 1-5.

In certain embodiments, the oversight server 160 may communicate the sensor data 130 and the proposed trajectory 480, 476 to a third party 360 and receive input from the third party 360, similar to that described in FIG. 5. The oversight server 160 may update the proposed trajectory 480, 476 based on the received input and transmit the updated trajectory 480, 476 to the control device 850 for the autonomous vehicle navigation.

### Example Autonomous Vehicle and Its Operation

FIG. 8 shows a block diagram of an example vehicle ecosystem 800 in which autonomous driving operations can be determined. As shown in FIG. 8, the autonomous vehicle 802 may be a semi-trailer truck. The vehicle ecosystem 800 may include several systems and components that can generate and/or deliver one or more sources of information/data and related services to the in-vehicle control computer 850 that may be located in an autonomous vehicle 802. The in-vehicle control computer 850 can be in data communication with a plurality of vehicle subsystems 840, all of which can be resident in the autonomous vehicle 802. A vehicle subsystem interface 860 may be provided to facilitate data communication between the in-vehicle control computer 850 and the plurality of vehicle subsystems 840. In some embodiments, the vehicle subsystem interface 860 can include a controller area network (CAN) controller to communicate with devices in the vehicle subsystems 840.

The autonomous vehicle 802 may include various vehicle subsystems that support the operation of the autonomous vehicle 802. The vehicle subsystems 840 may include a vehicle drive subsystem 842, a vehicle sensor subsystem 844, a vehicle control subsystem 848, and/or network communication subsystem 892. The components or devices of the vehicle drive subsystem 842, the vehicle sensor subsystem 844, and the vehicle control subsystem 848 shown in FIG. 8 are examples. The autonomous vehicle 802 may be configured as shown or any other configurations.

The vehicle drive subsystem 842 may include components operable to provide powered motion for the autonomous vehicle 802. In an example embodiment, the vehicle drive subsystem 842 may include an engine/motor 842a, wheels/tires 842b, a transmission 842c, an electrical subsystem 842d, and a power source 842e.

The vehicle sensor subsystem 844 may include a number of sensors 846 configured to sense information about an environment or condition of the autonomous vehicle 802. The vehicle sensor subsystem 844 may include one or more cameras 846a or image capture devices, a radar unit 846b, one or more thermal sensors 846c, a wireless communication unit 846d (e.g., a cellular communication transceiver), an inertial measurement unit (IMU) 846e, a laser range finder/LiDAR unit 846f, a Global Positioning System (GPS) transceiver 846g, a wiper control system 846h. The vehicle sensor subsystem 844 may also include sensors configured to monitor internal systems of the autonomous vehicle 802 (e.g., an O2 monitor, a fuel gauge, an engine oil temperature, etc.).

The IMU 846e may include any combination of sensors (e.g., accelerometers and gyroscopes) configured to sense position and orientation changes of the autonomous vehicle 802 based on inertial acceleration. The GPS transceiver 846g may be any sensor configured to estimate a geographic location of the autonomous vehicle 802. For this purpose, the GPS transceiver 846g may include a receiver/transmitter operable to provide information regarding the position of the autonomous vehicle 802 with respect to the Earth. The radar unit 846b may represent a system that utilizes radio signals to sense objects within the local environment of the autonomous vehicle 802. In some embodiments, in addition to sensing the objects, the radar unit 846b may additionally be configured to sense the speed and the heading of the objects proximate to the autonomous vehicle 802. The laser range finder or LiDAR unit 846f may be any sensor configured to use lasers to sense objects in the environment in which the autonomous vehicle 802 is located. The cameras 846a may include one or more devices configured to capture a plurality of images of the environment of the autonomous vehicle 802. The cameras 846a may be still image cameras or motion video cameras.

Cameras 846a may be rear-facing and front-facing so that pedestrians, and any hand signals made by them or signs held by pedestrians, may be observed from all around the autonomous vehicle. These cameras 846a may include video cameras, cameras with filters for specific wavelengths, as well as any other cameras suitable to detect hand signals, hand-held traffic signs, or both hand signals and hand-held traffic signs. A sound detection array, such as a microphone or array of microphones, may be included in the vehicle sensor subsystem 844. The microphones of the sound detection array may be configured to receive audio indications of the presence of, or instructions from, authorities, including sirens and commands such as “Pull over.” These microphones are mounted, or located, on the external portion of the vehicle, specifically on the outside of the tractor portion of an autonomous vehicle. Microphones used may be any suitable type, mounted such that they are effective both when the autonomous vehicle is at rest, as well as when it is moving at normal driving speeds.

The vehicle control subsystem 848 may be configured to control the operation of the autonomous vehicle 802 and its components. Accordingly, the vehicle control subsystem 848 may include various elements such as a throttle and gear selector 848a, a brake unit 848b, a navigation unit 848c, a steering system 848d, and/or an autonomous control unit 848e. The throttle and gear selector 848a may be configured to control, for instance, the operating speed of the engine and, in turn, control the speed of the autonomous vehicle 802. The throttle and gear selector 848a may be configured to control the gear selection of the transmission. The brake unit 848b can include any combination of mechanisms configured to decelerate the autonomous vehicle 802. The brake unit 848b can slow the autonomous vehicle 802 in a standard manner, including by using friction to slow the wheels or engine braking. The brake unit 848b may include an anti-lock brake system (ABS) that can prevent the brakes from locking up when the brakes are applied. The navigation unit 848c may be any system configured to determine a driving path or route for the autonomous vehicle 802. The navigation unit 848c may additionally be configured to update the driving path dynamically while the autonomous vehicle 802 is in operation. In some embodiments, the navigation unit 848c may be configured to incorporate data from the GPS transceiver 846g and one or more predetermined maps so as to determine the driving path for the autonomous vehicle 802. The steering system 848d may represent any combination of mechanisms that may be operable to adjust the heading of autonomous vehicle 802 in an autonomous mode or in a driver-controlled mode.

The autonomous control unit 848e may represent a control system configured to identify, evaluate, and avoid or otherwise negotiate potential obstacles or obstructions in the environment of the autonomous vehicle 802. In general, the autonomous control unit 848e may be configured to control the autonomous vehicle 802 for operation without a driver or to provide driver assistance in controlling the autonomous vehicle 802. In some embodiments, the autonomous control unit 848e may be configured to incorporate data from the GPS transceiver 846g, the radar unit 846b, the LiDAR unit 846f, the cameras 846a, and/or other vehicle subsystems to determine the driving path or trajectory for the autonomous vehicle 802.

The network communication subsystem 892 may comprise network interfaces, such as routers, switches, modems, and/or the like. The network communication subsystem 892 may be configured to establish communication between the autonomous vehicle 802 and other systems, servers, etc. The network communication subsystem 892 may be further configured to send and receive data from and to other systems.

Many or all of the functions of the autonomous vehicle 802 can be controlled by the in-vehicle control computer 850. The in-vehicle control computer 850 may include at least one data processor 870 (which can include at least one microprocessor) that executes processing instructions 880 stored in a non-transitory computer-readable medium, such as the data storage device 890 or memory. The in-vehicle control computer 850 may also represent a plurality of computing devices that may serve to control individual components or subsystems of the autonomous vehicle 802 in a distributed fashion. In some embodiments, the data storage device 890 may contain processing instructions 880 (e.g., program logic) executable by the data processor 870 to perform various methods and/or functions of the autonomous vehicle 802, including those described with respect to FIGS. 1-10.

The data storage device 890 may contain additional instructions as well, including instructions to transmit data to, receive data from, interact with, or control one or more of the vehicle drive subsystem 842, the vehicle sensor subsystem 844, and the vehicle control subsystem 848. The in-vehicle control computer 850 can be configured to include a data processor 870 and a data storage device 890. The in-vehicle control computer 850 may control the function of the autonomous vehicle 802 based on inputs received from various vehicle subsystems (e.g., the vehicle drive subsystem 842, the vehicle sensor subsystem 844, and the vehicle control subsystem 848).

FIG. 9 shows an exemplary system 900 for providing precise autonomous driving operations. The system 900 may include several modules that can operate in the in-vehicle control computer 850, as described in FIG. 8. The in-vehicle control computer 850 may include a sensor fusion module 902 shown in the top left corner of FIG. 9, where the sensor fusion module 902 may perform at least four image or signal processing operations. The sensor fusion module 902 can obtain images from cameras located on an autonomous vehicle to perform image segmentation 904 to detect the presence of moving objects (e.g., other vehicles, pedestrians, etc.,) and/or static obstacles (e.g., stop sign, speed bump, terrain, etc.,) located around the autonomous vehicle. The sensor fusion module 902 can obtain LiDAR point cloud data item from LiDAR sensors located on the autonomous vehicle to perform LiDAR segmentation 906 to detect the presence of objects and/or obstacles located around the autonomous vehicle.

The sensor fusion module 902 can perform instance segmentation 908 on image and/or point cloud data items to identify an outline (e.g., boxes) around the objects and/or obstacles located around the autonomous vehicle. The sensor fusion module 902 can perform temporal fusion 910 where objects and/or obstacles from one image and/or one frame of point cloud data item are correlated with or associated with objects and/or obstacles from one or more images or frames subsequently received in time.

The sensor fusion module 902 can fuse the objects and/or obstacles from the images obtained from the camera and/or point cloud data item obtained from the LiDAR sensors. For example, the sensor fusion module 902 may determine based on a location of two cameras that an image from one of the cameras comprising one half of a vehicle located in front of the autonomous vehicle is the same as the vehicle captured by another camera. The sensor fusion module 902 may send the fused object information to the tracking or prediction module 946 and the fused obstacle information to the occupancy grid module 960. The in-vehicle control computer may include the occupancy grid module 960 which can retrieve landmarks from a map database 958 stored in the in-vehicle control computer. The occupancy grid module 960 can determine drivable areas and/or obstacles from the fused obstacles obtained from the sensor fusion module 902 and the landmarks stored in the map database 958. For example, the occupancy grid module 960 can determine that a drivable area may include a speed bump obstacle.

Below the sensor fusion module 902, the in-vehicle control computer 850 may include a LiDAR-based object detection module 912 that can perform object detection 916 based on point cloud data item obtained from the LiDAR sensors 914 located on the autonomous vehicle. The object detection 916 technique can provide a location (e.g., in 3D world coordinates) of objects from the point cloud data item. Below the LiDAR-based object detection module 912, the in-vehicle control computer may include an image-based object detection module 918 that can perform object detection 924 based on images obtained from cameras 920 located on the autonomous vehicle. For example, the object detection 918 technique can employ a deep image based object detection 924 (e.g., a machine learning technique) to provide a location (e.g., in 3D world coordinates) of objects from the image provided by the camera 920.

The radar 956 on the autonomous vehicle can scan an area in front of the autonomous vehicle or an area towards which the autonomous vehicle is driven. The radar data may be sent to the sensor fusion module 902 that can use the radar data to correlate the objects and/or obstacles detected by the radar 956 with the objects and/or obstacles detected from both the LiDAR point cloud data item and the camera image. The radar data also may be sent to the tracking or prediction module 946 that can perform data processing on the radar data to track objects by object tracking module 948 as further described below.

The in-vehicle control computer may include an tracking or prediction module 946 that receives the locations of the objects from the point cloud and the objects from the image, and the fused objects from the sensor fusion module 902. The tracking or prediction module 946 also receives the radar data with which the tracking or prediction module 946 can track objects by object tracking module 948 from one point cloud data item and one image obtained at one time instance to another (or the next) point cloud data item and another image obtained at another subsequent time instance.

The tracking or prediction module 946 may perform object attribute estimation 950 to estimate one or more attributes of an object detected in an image or point cloud data item. The one or more attributes of the object may include a type of object (e.g., pedestrian, car, or truck, etc.). The tracking or prediction module 946 may perform behavior prediction 952 to estimate or predict the motion pattern of an object detected in an image and/or a point cloud. The behavior prediction 952 can be performed to detect a location of an object in a set of images received at different points in time (e.g., sequential images) or in a set of point cloud data items received at different points in time (e.g., sequential point cloud data items). In some embodiments, the behavior prediction 952 can be performed for each image received from a camera and/or each point cloud data item received from the LiDAR sensor. In some embodiments, the tracking or prediction module 946 can be performed (e.g., run or executed) to reduce computational load by performing behavior prediction 952 on every other or after every pre-determined number of images received from a camera or point cloud data item received from the LiDAR sensor (e.g., after every two images or after every three-point cloud data items).

The behavior prediction 952 feature may determine the speed and direction of the objects that surround the autonomous vehicle from the radar data, where the speed and direction information can be used to predict or determine motion patterns of objects. A motion pattern may comprise a predicted trajectory information of an object over a pre-determined length of time in the future after an image is received from a camera. Based on the motion pattern predicted, the tracking or prediction module 946 may assign motion pattern situational tags to the objects (e.g., “located at coordinates (x,y),” “stopped,” “driving at 50 mph,” “speeding up” or “slowing down”). The situation tags can describe the motion pattern of the object. The tracking or prediction module 946 may send the one or more object attributes (e.g., types of the objects) and motion pattern situational tags to the planning module 962. The tracking or prediction module 946 may perform an environment analysis 954 using any information acquired by system 900 and any number and combination of its components.

The in-vehicle control computer may include the planning module 962 that receives the object attributes and motion pattern situational tags from the tracking or prediction module 946, the drivable area and/or obstacles, and the vehicle location and pose information from the fused localization module 926 (further described below).

The planning module 962 can perform navigation planning 964 to determine a set of trajectories on which the autonomous vehicle can be driven. The set of trajectories can be determined based on the drivable area information, the one or more object attributes of objects, the motion pattern situational tags of the objects, location of the obstacles, and the drivable area information. In some embodiments, the navigation planning 964 may include determining an area next to the road where the autonomous vehicle can be safely parked in a case of emergencies. The planning module 962 may include behavioral decision making 966 to determine driving actions (e.g., steering, braking, throttle) in response to determining changing conditions on the road (e.g., traffic light turned yellow, or the autonomous vehicle is in an unsafe driving condition because another vehicle drove in front of the autonomous vehicle and in a region within a pre-determined safe distance of the location of the autonomous vehicle). The planning module 962 performs trajectory generation 968 and selects a trajectory from the set of trajectories determined by the navigation planning operation 964. The selected trajectory information may be sent by the planning module 962 to the control module 970.

The in-vehicle control computer may include a control module 970 that receives the proposed trajectory from the planning module 962 and the autonomous vehicle location and pose from the fused localization module 926. The control module 970 may include a system identifier 972. The control module 970 can perform a model-based trajectory refinement 974 to refine the proposed trajectory. For example, the control module 970 can apply filtering (e.g., Kalman filter) to make the proposed trajectory data smooth and/or to minimize noise. The control module 970 may perform the robust control 976 by determining, based on the refined proposed trajectory information and current location and/or pose of the autonomous vehicle, an amount of brake pressure to apply, a steering angle, a throttle amount to control the speed of the vehicle, and/or a transmission gear. The control module 970 can send the determined brake pressure, steering angle, throttle amount, and/or transmission gear to one or more devices in the autonomous vehicle to control and facilitate precise driving operations of the autonomous vehicle.

The deep image-based object detection 924 performed by the image-based object detection module 918 can also be used detect landmarks (e.g., stop signs, speed bumps, etc.,) on the road. The in-vehicle control computer may include a fused localization module 926 that obtains landmarks detected from images, the landmarks obtained from a map database 936 stored on the in-vehicle control computer, the landmarks detected from the point cloud data item by the LiDAR-based object detection module 912, the speed and displacement from the odometer sensor 944, or a rotary encoder, and the estimated location of the autonomous vehicle from the GPS/IMU sensor 938 (i.e., GPS sensor 940 and IMU sensor 942) located on or in the autonomous vehicle. Based on this information, the fused localization module 926 can perform a localization operation 928 to determine a location of the autonomous vehicle, which can be sent to the planning module 962 and the control module 970.

The fused localization module 926 can estimate pose 930 of the autonomous vehicle based on the GPS and/or IMU sensors 938. The pose of the autonomous vehicle can be sent to the planning module 962 and the control module 970. The fused localization module 926 can also estimate status (e.g., location, possible angle of movement) of the trailer unit based on (e.g., trailer status estimation 934), for example, the information provided by the IMU sensor 942 (e.g., angular rate and/or linear velocity). The fused localization module 926 may also check the map content 932.

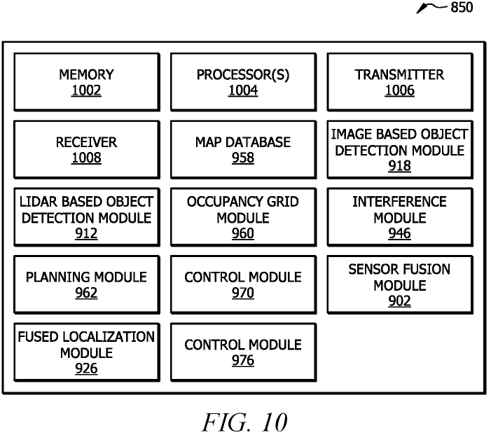

FIG. 10 shows an exemplary block diagram of an in-vehicle control computer 850 included in an autonomous vehicle 802. The in-vehicle control computer 850 may include at least one processor 1004 and a memory 1002 having instructions stored thereupon (e.g., software instructions 128 and processing instructions 880 in FIGS. 1 and 8, respectively). The instructions, upon execution by the processor 1004, configure the in-vehicle control computer 850 and/or the various modules of the in-vehicle control computer 850 to perform the operations described in FIGS. 1-10. The transmitter 1006 may transmit or send information or data to one or more devices in the autonomous vehicle. For example, the transmitter 1006 can send an instruction to one or more motors of the steering wheel to steer the autonomous vehicle. The receiver 1008 receives information or data transmitted or sent by one or more devices. For example, the receiver 1008 receives a status of the current speed from the odometer sensor or the current transmission gear from the transmission. The transmitter 1006 and receiver 1008 also may be configured to communicate with the plurality of vehicle subsystems 840 and the in-vehicle control computer 850 described above in FIGS. 8 and 9.

While several embodiments have been provided in this disclosure, it should be understood that the disclosed systems and methods might be embodied in many other specific forms without departing from the spirit or scope of this disclosure. The present examples are to be considered as illustrative and not restrictive, and the intention is not to be limited to the details given herein. For example, the various elements or components may be combined or integrated into another system or certain features may be omitted, or not implemented.

In addition, techniques, systems, subsystems, and methods described and illustrated in the various embodiments as discrete or separate may be combined or integrated with other systems, modules, techniques, or methods without departing from the scope of this disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

Implementations of the disclosure can be described in view of the following clauses, the features of which can be combined in any reasonable manner.

Clause 1. A system comprising:
an autonomous vehicle configured to travel along a road, wherein the autonomous vehicle comprises at least one sensor;
a control device associated with the autonomous vehicle and comprising a first processor configured to:
   access sensor data captured by the at least one sensor, wherein the sensor data provides information about at least a portion of an area in front of the autonomous vehicle;
   detect, from the sensor data, a road anomaly comprising one of a road accident, a road closure, or congested traffic;
   detect, from the sensor data, that an emergency personnel is altering a traffic flow using an emergency-related hand signal, wherein the emergency personnel is on a traffic lane adjacent to the road anomaly and facing oncoming traffic;
   determine an interpretation of the emergency-related hand signal;
   determine a proposed trajectory for the autonomous vehicle according to the interpretation of the emergency-related hand signal; and
   navigate the autonomous vehicle according to the proposed trajectory.

Clause 2. The system of Clause 1, wherein the emergency personnel is a law enforcement officer, a firefighter, or a paramedic.

Clause 3. The system of Clause 1, wherein detecting, from the sensor data, that the emergency personnel is altering the traffic flow using the emergency-related hand signal comprises determining that the emergency personnel is wearing a law enforcement uniform, a firefighter uniform, or a paramedic uniform.

Clause 4. The system of Clause 1, wherein:
the emergency-related hand signal is hand motions or waving a flag that indicate all vehicles stop; and
the proposed trajectory follows the interpretation of the emergency-related hand signal, such that if the interpretation of the emergency-related hand signal is all vehicles stop, the proposed trajectory is stopping.

Clause 5. The system of Clause 1, wherein:
the emergency-related hand signal is hand motions or waving a flag that indicate all vehicles proceed; and
the proposed trajectory follows the interpretation of the emergency-related hand signal, such that if the interpretation of the emergency-related hand signal is all vehicles proceed, the proposed trajectory is moving forward.

Clause 6. The system of Clause 1, wherein:
the emergency-related hand signal is hand motions or waving a flag that indicate vehicles on right, front, and behind to stop, and vehicles on a left side to proceed;
the proposed trajectory follows the interpretation of the emergency-related hand signal, such that if the interpretation of the emergency-related hand signal is vehicles on right, front, and behind of the emergency personnel to stop, and vehicles on the left side to proceed:
   the proposed trajectory is moving forward if the autonomous vehicle is on the left side of the emergency personnel; and
   the proposed trajectory is stopping if the autonomous vehicle is on any of the right, front, and behind of the emergency personnel.

Clause 7. The system of Clause 1, wherein determining the interpretation of the emergency-related hand signal comprises:
accessing a training dataset comprising a plurality of images, wherein a respective image, from among the plurality of images, is labeled with an interpretation of a hand signal shown in the respective image;
extracting a first set of features from the sensor data where the emergency-related hand signal is detected, wherein:
   the first set of features indicates a type of the emergency-related hand signal;
   the first set of features is represented by a first vector comprising numerical values;
   extracting a second set of features from an image of the plurality of images, wherein:
   the image shows a particular hand signal;
   the image is labeled with a particular interpretation of the particular hand signal;
   the second set of features indicates a type of the particular hand signal;
   the second set of features is represented by a second vector comprising numerical values;
   determining a distance between the first vector and the second vector; and
in response to determining that the distance between the first vector and the second vector is less than a threshold percentage, determining that the interpretation of the emergency-related hand signal corresponds to the particular interpretation of the particular hand signal.

Clause 8. The system of Clause 1, wherein detecting, from the sensor data, the road anomaly comprises:
extracting a set of features from the sensor data, wherein the set of features indicates physical attributes of objects indicated in the sensor data; and
determining that the objects include an object associated with the road anomaly, wherein the object comprises a traffic cone or a traffic barrier.

Clause 9. The system of Clause 1, wherein the first processor is further configured to transmit the proposed trajectory to one or more other autonomous vehicles.

Clause 10. The system of Clause 1, wherein the sensor data comprises at least one of a camera video, a camera image data, and a light detection and ranging (LiDAR) cloud data.

Clause 11. A system comprising:
an autonomous vehicle configured to travel along a road, wherein the autonomous vehicle comprises at least one sensor;
a control device associated with the autonomous vehicle and comprising a first processor configured to:
   access sensor data captured by the at least one sensor, wherein the sensor data provides information about at least a portion of an area in front of the autonomous vehicle;
   detect, from the sensor data, a road anomaly comprising one of a road accident,
   a road closure, or congested traffic;
   detect, from the sensor data, that an emergency personnel is altering a traffic flow using an emergency-related hand signal, wherein the emergency personnel is on a traffic lane adjacent to the road anomaly and facing oncoming traffic;
   determine an interpretation of the emergency-related hand signal;
   determine a proposed trajectory for the autonomous vehicle according to the interpretation of the emergency-related hand signal; and
   transmit at least one of the proposed trajectory and the sensor data to an oversight server;
the oversight server operably coupled with the control device, and comprising a second processor configured to:
   receive the at least one of the proposed trajectory and the sensor data;
   determine whether the emergency-related hand signal is in use to alter the traffic flow;
   in response to determining that the emergency-related hand signal is in use to alter the traffic flow, determine whether the proposed trajectory causes the autonomous vehicle to go outside of an operational design domain that indicates pre-mapped geographical areas where the autonomous vehicle is able to autonomously travel; and
   in response to determining that the proposed trajectory does not cause the autonomous vehicle to go outside of the operational design domain, transmit, to the control device, an instruction that indicates to perform the proposed trajectory.

Clause 12. The system of Clause 11, wherein the first processor is further configured to:
receive the instruction from the oversight server; and
navigate the autonomous vehicle according to the proposed trajectory.

Clause 13. The system of Clause 11, wherein the second processor is further configured, in response to determining that the emergency-related hand signal is not in use to alter the traffic flow, to:
determine a second proposed trajectory for the autonomous vehicle; and
transmit the second proposed trajectory to the control device.

Clause 14. The system of Clause 13, wherein the first processor is further configured to:
receive the second proposed trajectory from the oversight server; and
navigate the autonomous vehicle according to the second proposed trajectory.

Clause 15. The system of Clause 11, wherein the second processor is further configured, in response to determining that the proposed trajectory causes the autonomous vehicle to go outside of the operational design domain, to:
determine a third proposed trajectory for the autonomous vehicle; and
transmit the third proposed trajectory to the control device.

Clause 16. The system of Clause 15, wherein the first processor is further configured to:
receive, from the oversight server, the third proposed trajectory; and
navigate the autonomous vehicle according to the third proposed trajectory.

Clause 17. The system of Clause 11, wherein the second processor is further configured to transmit the proposed trajectory to one or more other autonomous vehicles.

Clause 18. The system of Clause 11, wherein determining whether the emergency-related hand signal is in use to alter the traffic flow comprises:
accessing map data that comprises at least a portion of a map of a city that includes the road;
determining, from the map data, that the autonomous vehicle is traveling within a particular area where is known hand signals are used to control traffic, wherein the particular area comprises one of a school road crossing area, a construction area, or a road accident area; and
prioritizing an analysis of the sensor data for hand signal detection, wherein the sensor data is captured when the autonomous vehicle is traveling within the particular area.

Clause 19. The system of Clause 18, wherein determining whether the emergency-related hand signal is in use to alter the traffic flow comprises:
determining that the autonomous vehicle is traveling within the particular area during a particular time window, wherein the particular time window comprises one of active hours of a construction site, school opening hours, or school closing hours; and
prioritizing an analysis of the sensor data for hand signal detection, wherein the sensor data is captured during the particular time window.

Clause 20. The system of Clause 11, wherein the second processor is further configured to:
communicate the sensor data to a third party;
communicate the proposed trajectory to the third party;
receive an input from the third party regarding one or more traveling parameters to prioritize, wherein the one or more traveling parameters comprise a speed, a fuel-saving parameter, or maintaining an originally planned route;
update the proposed trajectory based on the received input; and
transmit the updated trajectory to the control device.

1. A system comprising:
an autonomous vehicle configured to travel along a road, wherein the autonomous vehicle comprises at least one sensor;
a control device associated with the autonomous vehicle and comprising a first processor configured to:
access sensor data captured by the at least one sensor, wherein the sensor data provides information about at least a portion of an area in front of the autonomous vehicle;
detect, from the sensor data, a road anomaly comprising one of a road accident, a road closure, or congested traffic;
detect, from the sensor data, that an emergency personnel is altering a traffic flow using an emergency-related hand signal, wherein the emergency personnel is on a traffic lane adjacent to the road anomaly and facing oncoming traffic;
determine an interpretation of the emergency-related hand signal;
determine a proposed trajectory for the autonomous vehicle according to the interpretation of the emergency-related hand signal; and
navigate the autonomous vehicle according to the proposed trajectory.

2. The system of claim 1, wherein the emergency personnel is a law enforcement officer, a firefighter, or a paramedic.

3. The system of claim 1, wherein detecting, from the sensor data, that the emergency personnel is altering the traffic flow using the emergency-related hand signal comprises determining that the emergency personnel is wearing a law enforcement uniform, a firefighter uniform, or a paramedic uniform.

4. The system of claim 1, wherein:
the emergency-related hand signal is hand motions or waving a flag that indicate all vehicles stop; and
the proposed trajectory follows the interpretation of the emergency-related hand signal, such that if the interpretation of the emergency-related hand signal is all vehicles stop, the proposed trajectory is stopping.

5. The system of claim 1, wherein:
the emergency-related hand signal is hand motions or waving a flag that indicate all vehicles proceed; and
the proposed trajectory follows the interpretation of the emergency-related hand signal, such that if the interpretation of the emergency-related hand signal is all vehicles proceed, the proposed trajectory is moving forward.

6. The system of claim 1, wherein:
the emergency-related hand signal is hand motions or waving a flag that indicate vehicles on right, front, and behind to stop, and vehicles on a left side to proceed;
the proposed trajectory follows the interpretation of the emergency-related hand signal, such that if the interpretation of the emergency-related hand signal is vehicles on right, front, and behind of the emergency personnel to stop, and vehicles on the left side to proceed:
the proposed trajectory is moving forward if the autonomous vehicle is on the left side of the emergency personnel; and
the proposed trajectory is stopping if the autonomous vehicle is on any of the right, front, and behind of the emergency personnel.

7. The system of claim 1, wherein determining the interpretation of the emergency-related hand signal comprises:
accessing a training dataset comprising a plurality of images, wherein a respective image, from among the plurality of images, is labeled with an interpretation of a hand signal shown in the respective image;
extracting a first set of features from the sensor data where the emergency-related hand signal is detected, wherein:
the first set of features indicates a type of the emergency-related hand signal;
the first set of features is represented by a first vector comprising numerical values;
extracting a second set of features from an image of the plurality of images, wherein:
the image shows a particular hand signal;
the image is labeled with a particular interpretation of the particular hand signal;
the second set of features indicates a type of the particular hand signal;
the second set of features is represented by a second vector comprising numerical values;
determining a distance between the first vector and the second vector; and
in response to determining that the distance between the first vector and the second vector is less than a threshold percentage, determining that the interpretation of the emergency-related hand signal corresponds to the particular interpretation of the particular hand signal.

8. The system of claim 1, wherein detecting, from the sensor data, the road anomaly comprises:
extracting a set of features from the sensor data, wherein the set of features indicates physical attributes of objects indicated in the sensor data; and
determining that the objects include an object associated with the road anomaly, wherein the object comprises a traffic cone or a traffic barrier.

9. The system of claim 1, wherein the first processor is further configured to transmit the proposed trajectory to one or more other autonomous vehicles.

10. The system of claim 1, wherein the sensor data comprises at least one of a camera video, a camera image data, and a light detection and ranging (LiDAR) cloud data.

11. A system comprising:
an autonomous vehicle configured to travel along a road, wherein the autonomous vehicle comprises at least one sensor;
a control device associated with the autonomous vehicle and comprising a first processor configured to:
access sensor data captured by the at least one sensor, wherein the sensor data provides information about at least a portion of an area in front of the autonomous vehicle;
detect, from the sensor data, a road anomaly comprising one of a road accident, a road closure, or congested traffic;
detect, from the sensor data, that an emergency personnel is altering a traffic flow using an emergency-related hand signal, wherein the emergency personnel is on a traffic lane adjacent to the road anomaly and facing oncoming traffic;
determine an interpretation of the emergency-related hand signal;
determine a proposed trajectory for the autonomous vehicle according to the interpretation of the emergency-related hand signal; and
transmit at least one of the proposed trajectory and the sensor data to an oversight server;
the oversight server operably coupled with the control device, and comprising a second processor configured to:
receive the at least one of the proposed trajectory and the sensor data;
determine whether the emergency-related hand signal is in use to alter the traffic flow;
in response to determining that the emergency-related hand signal is in use to alter the traffic flow, determine whether the proposed trajectory causes the autonomous vehicle to go outside of an operational design domain that indicates pre-mapped geographical areas where the autonomous vehicle is able to autonomously travel; and
in response to determining that the proposed trajectory does not cause the autonomous vehicle to go outside of the operational design domain, transmit, to the control device, an instruction that indicates to perform the proposed trajectory.

12. The system of claim 11, wherein the first processor is further configured to:
receive the instruction from the oversight server; and
navigate the autonomous vehicle according to the proposed trajectory.

13. The system of claim 11, wherein the second processor is further configured, in response to determining that the emergency-related hand signal is not in use to alter the traffic flow, to:
determine a second proposed trajectory for the autonomous vehicle; and
transmit the second proposed trajectory to the control device.

14. The system of claim 13, wherein the first processor is further configured to:
receive the second proposed trajectory from the oversight server; and
navigate the autonomous vehicle according to the second proposed trajectory.

15. The system of claim 11, wherein the second processor is further configured, in response to determining that the proposed trajectory causes the autonomous vehicle to go outside of the operational design domain, to:
determine a third proposed trajectory for the autonomous vehicle; and
transmit the third proposed trajectory to the control device.

16. The system of claim 15, wherein the first processor is further configured to:
receive, from the oversight server, the third proposed trajectory; and
navigate the autonomous vehicle according to the third proposed trajectory.

17. The system of claim 11, wherein the second processor is further configured to transmit the proposed trajectory to one or more other autonomous vehicles.

18. The system of claim 11, wherein determining whether the emergency-related hand signal is in use to alter the traffic flow comprises:
accessing map data that comprises at least a portion of a map of a city that includes the road;
determining, from the map data, that the autonomous vehicle is traveling within a particular area where is known hand signals are used to control traffic, wherein the particular area comprises one of a school road crossing area, a construction area, or a road accident area; and
prioritizing an analysis of the sensor data for hand signal detection, wherein the sensor data is captured when the autonomous vehicle is traveling within the particular area.

19. The system of claim 18, wherein determining whether the emergency-related hand signal is in use to alter the traffic flow comprises:
determining that the autonomous vehicle is traveling within the particular area during a particular time window, wherein the particular time window comprises one of active hours of a construction site, school opening hours, or school closing hours; and
prioritizing an analysis of the sensor data for hand signal detection, wherein the sensor data is captured during the particular time window.

20. The system of claim 11, wherein the second processor is further configured to:
communicate the sensor data to a third party;
communicate the proposed trajectory to the third party;
receive an input from the third party regarding one or more traveling parameters to prioritize, wherein the one or more traveling parameters comprise a speed, a fuel-saving parameter, or maintaining an originally planned route;
update the proposed trajectory based on the received input; and
transmit the updated trajectory to the control device.
